(19) United States
(12) Patent Application Publication
(10) Pub. No.: US 2003/0092868 A1
(43) Pub. Date: May 15, 2003

(54) Non-aqueous laminate adhesive

(76) Inventors: Yukihiro Morikawa, Kanagawa -ken (JP); Ichiro Higashikubo, Kanagawa-ken (JP); Kouji Yoshida, Kanagawa-ken (JP); Toshiaki Sasahara, Kanagawa-ken (JP)

Correspondence Address: BROWDY AND NEIMARK, P.L.L.C., 624 NINTH STREET, NW, SUITE 300, WASHINGTON, DC, 20001-5303, US

(21) Appl. No.: 09/910,866

(22) Filed: Jul. 24, 2001

(51) Int. Cl. C09J 175/12; C09J 175/04; C09J 175/08; C08G 18/32; C08G 18/34; C08G 18/71; C08G 18/50; C08G 18/48

(52) U.S. Cl. 528/69; 528/28; 528/78; 528/85; 528/71; 528/905; 156/331.4; 156/331.7

(57) ABSTRACT

A non-aqueous laminate adhesive comprising a tertiary amino group-containing polyurethane resin (A) or a tertiary amino group- and carboxyl group-containing polyurethane resin (B) and a polyisocyanate curing agent. The resin (A) is obtained from (1) an active hydrogen group-containing compound comprising at least a tertiary amino group- and hydroxyl group-containing compound and (3) an organic polyisocyanate; and the resin (B) is obtained from (2) an active hydrogen group-containing compound comprising at least a tertiary amino group- and hydroxyl group-containing compound and a carboxyl group- and hydroxyl group-containing compound and (3) an organic polyisocyanate. The content of the tertiary amino group in the resin (A), the content of the tertiary amino group in the resin (B), and the carboxyl group in the resin (B) are each 0.001 to 1 mmol/g.

The non-aqueous laminate adhesive has a short aging time, a long pot life and good storage stability, all of which have been unachievable with conventional laminate adhesives.

### BACKGROUND OF THE INVENTION

(1) Field of the Invention

The present invention relates to a non-aqueous laminate adhesive suitably used in production of a laminated film.

(2) Related Prior Art

Recently, as a packaging method, complex flexible packaging has been remarkably developed for reasons such as strength of package, protectability for goods packed, workability during packaging, propaganda effect of package, reduction of packaging cost caused by the use of a film supplied in a large amount at a low cost, and the like. In the complex flexible packaging, there is used a laminated film or sheet produced using an adhesive. The current main stream of such a laminate adhesive is a two-pack type polyurethane adhesive generally composed of a base resin having active hydrogen group and a curing agent having isocyanate group, because the two-pack type polyurethane adhesive is excellent in adhesivity, low-temperature resistance and heat resistance and further it can be widely applied to various adherends such as plastics, metal foils and the like.

As such a laminate adhesive, there is disclosed, in JP-A-63-110272, a composite laminate adhesive composition comprising:

one or more kinds of polyols selected from polyether polyols, polyester polyols, polyether urethane polyols and polyester urethane polyols,

an isocyanate group-containing silane coupling agent, and

a polyisocyanate curing agent.

In laminate adhesives, the shortening of curing time has been required. In most of the curing agents used in conventional laminate adhesives, however, no consideration has been made on the reactivity with the base resin. As a result, the curing of adhesive after application is slow, making necessary a step of curing acceleration, i.e. aging. Specifically explaining, it is necessary to store a laminated film in a warm chamber of 35 to 60° C. for about 3 to 5 days to conduct aging and cure the adhesive used in the laminated film. At that time, the curing degree of the adhesive differs depending upon the aging conditions, which may allow the laminated film to vary in adhesion strength; in case of insufficient aging, delamination due to the insufficient curing of the adhesive may take place. Particularly in aliphatic polyurethane adhesives, a fairly long time is needed for the curing reaction. Such an aging step is essential in a dry lamination process and makes it difficult to respond to a request for short delivery period. Also in the aging step, there have been necessary an investment for construction of a warm house for conducting aging and a cost for utilities for temperature maintenance. In the technique described in JP-A-63-110272, no consideration is made to the shortening of aging time although improvements are achieved in the adhesivity, chemical resistance and heat resistance of the laminate adhesive.

In order to achieve the shortening of aging time, it is generally effective to add a catalyst. As such a technique, there can be mentioned a technique described in JP-A-9-316422. In the technique described in JP-A-9-316422, a catalyst is added to a polyurethane resin (a solution); as a result, a shorter aging time is obtained, but there is a problem that the pot life after mixing of the base resin and the curing agent is shortened as well. An adhesive of short pot life tends to be used in an excessive amount and, moreover, solidify often and impair the applicator.

Thus, conventional two-pack type, polyurethane-based laminate adhesives are very slow in the curing reaction and need a long time for aging; therefore, an improvement therefor has been desired.

In order to alleviate these drawbacks of the above adhesives, addition of a tertiary amine thereto is effective. For example, in JP-A-11-50036 is proposed a two-pack type adhesive composition for dry lamination, using, as the polyol component, a carboxyl group-containing polyol wherein at least part of the carboxyl group is neutralized with a base. Also in JP-A-11-181394 is disclosed an adhesive for film, using an aqueous polyurethane resin having anionic group and cationic group.

It is well known that compounding of a silane coupling agent in an adhesive imparts improved adhesivity, heat resistance, chemical resistance, etc. to the adhesive. Mixing of three components, i.e. a base resin, a curing agent and a coupling agent at the time of film lamination incurs mistaken compounding or requires complicated apparatuses; therefore, it is necessary to compound the coupling agent beforehand in either of the base resin and the curing agent. However, beforehand compounding of the silane coupling agent in the base resin, particularly a base resin having functional groups such as amino group, epoxy group and the like may incur coloring and/or increasing in viscosity with the lapse of time. This is considered to be because the functional groups in the base resin react with the alkoxysilane moiety, etc. of the silane coupling agent. Further, since the silane coupling agent ordinarily has functional groups such as amino group, epoxy group and the like, compounding of a polyisocyanate curing agent with the silane coupling agent induces, as well, a reaction of the isocyanate group of the curing agent with the functional groups of the silane coupling agent, which may incur increasing in viscosity with the lapse of time.

In the tertiary amine-added adhesive, however, the tertiary amine functions as a catalyst and there easily takes place ester interchange with an ester type solvent (e.g. an acetic acid ester) or hydrolysis caused by the water contained in the solvent; as a result, the adhesive has heretofore caused reduction in viscosity or molecular weight and, resultantly, reduction in properties such as adhesion strength and the like. This has made impossible the long-term storage of the adhesive and an improvement therefor has been desired. Moreover, aqueous adhesives require a large amount of energy during the lamination therewith and wastes thereof are difficult to treat.

In laminate adhesives using a silane coupling agent, it is desired for the storage stability to store the components independently and compound them right before their use; this, however, requires a larger space for storage and a larger labor for components compounding. Therefore, a laminate adhesive composed of two components, free from such inconveniences has been desired.

### SUMMARY OF THE INVENTION

The present invention aims at providing a non-aqueous laminate adhesive having a short aging time, a long pot life, and excellent storage stability, productivity and workability.

The present inventors made a study in order to solve the above-mentioned problems of the prior art. As a result, the present inventors found out that the problems could be solved by a non-aqueous laminate adhesive which uses, as the main component of the base resin, a tertiary amino group- and active hydrogen group-containing polyurethane resin or a tertiary amino group-, carboxyl group- and active hydrogen group-containing polyurethane resin. The present invention has been completed based on the above finding.

The present invention lies in the following (1) to (4).

(1) A non-aqueous laminate adhesive comprising:

a tertiary amino group-containing polyurethane resin (A) obtained by reacting an active hydrogen group-containing compound comprising at least one or more kinds of compounds selected from the group consisting of compounds represented by the following formulas (1), (2), (3) and (4), with an organic polyisocyanate with the active hydrogen group being present in excess, and

a polyisocyanate curing agent,

wherein the content of the tertiary amino group in the tertiary amino group-containing polyurethane resin (A) is 0.001 to 1 mmol/g.

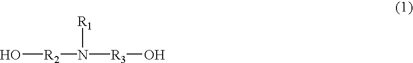

(wherein R₁ is a monovalent hydrocarbon group having 1 to 10 carbon atoms, and R₂ and R₃ may be the same or different and are each a divalent hydrocarbon group having 1 to 10 carbon atoms).

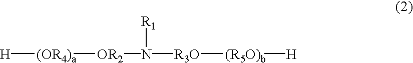

[wherein R₁ is a monovalent hydrocarbon group having 1 to 10 carbon atoms; R₂ and R₃ may be the same or different and are each a divalent hydrocarbon group having 1 to 10 carbon atoms; R₄ and R₅ may be the same or different and are each a divalent organic group having 1 to 10 carbon atoms; and a and b are each such an integer of 0 or more that the number-average molecular weight of the compound of the formula (2) becomes 300 to 10,000].

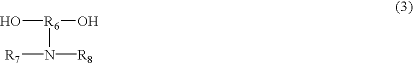

(wherein R₆ is a trivalent hydrocarbon group having 1 to 10 carbon atoms, and R₇ and R₈ may be the same or different and are each a monovalent hydrocarbon group having 1 to 10 carbon atoms).

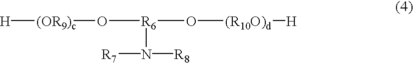

[wherein R₆ is a trivalent hydrocarbon group having 1 to 10 carbon atoms; R₇ and R₈ may be the same or different and are each a monovalent hydrocarbon group having 1 to 10 carbon atoms; R₉ and R₁₀ may be the same or different and are each a divalent organic group having 1 to 10 carbon atoms; and c and d are each such an integer of 0 or more that the number-average molecular weight of the compound of the formula (4) becomes 300 to 10,000].

(2) A non-aqueous laminate adhesive comprising:

a tertiary amino group-containing polyurethane resin (A) obtained by reacting an active hydrogen group-containing compound comprising at least one or more kinds of compounds selected from the group consisting of compounds represented by the following formulas (1), (2), (3) and (4), with an organic polyisocyanate with the active hydrogen group being present in excess,

a polyisocyanate curing agent, and

a silane coupling agent represented by the following formula (7),

wherein the content of the tertiary amino group in the tertiary amino group-containing polyurethane resin (A) is 0.001 to 1 mmol/g.

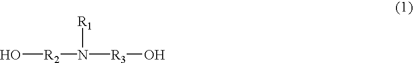

(wherein R₁ is a monovalent hydrocarbon group having 1 to 10 carbon atoms, and R₂ and R₃ may be the same or different and are each a divalent hydrocarbon group having 1 to 10 carbon atoms).

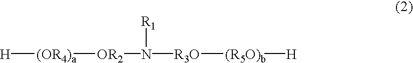

[wherein R₁ is a monovalent hydrocarbon group having 1 to 10 carbon atoms; R₂ and R₃ may be the same or different and are each a divalent hydrocarbon group having 1 to 10 carbon atoms; R₄ and R₅ may be the same or different and are each a divalent organic group having 1 to 10 carbon atoms; and a and b are each such an integer of 0 or more that the number-average molecular weight of the compound of the formula (2) becomes 300 to 10,000].

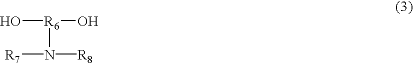

(wherein R₆ is a trivalent hydrocarbon group having 1 to 10 carbon atoms, and R₇ and R₈ may be the same or different and are each a monovalent hydrocarbon group having 1 to 10 carbon atoms).

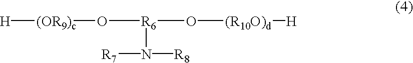

[wherein R₆ is a trivalent hydrocarbon group having 1 to 10 carbon atoms; R₇ and R₈ may be the same or different and are each a monovalent hydrocarbon group having 1 to 10 carbon atoms; R₉ and R₁₀ may be the same or different and are each a divalent organic group having 1 to 10 carbon atoms; and c and d are each such an integer of 0 or more that the number-average molecular weight of the compound of the formula (4) becomes 300 to 10,000].

OCN—(CH₂)ₘ—Si(OR)₃ (7)

(wherein R is a methyl group or an ethyl group, and m is an integer of 1 to 5).

(3) A non-aqueous laminate adhesive comprising:

a tertiary amino group- and carboxyl group-containing polyurethane resin (B) obtained by reacting an active hydrogen group-containing compound comprising at least (a) one or more kinds of compounds selected from the group consisting of compounds represented by the following formulas (1), (2), (3) and (4) and (b) one or two kinds of compounds selected from the group consisting of compounds represented by the following formulas (5) and (6), with an organic polyisocyanate with the active hydrogen group being present in excess, and

a polyisocyanate curing agent,

wherein the content of the tertiary amino group and the content of the carboxyl group in the tertiary amino group- and carboxyl group-containing polyurethane resin (B) are each 0.001 to 1 mmol/g.

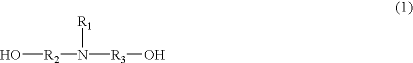

(wherein R₁ is a monovalent hydrocarbon group having 1 to 10 carbon atoms, and R₂ and R₃ may be the same or different and are each a divalent hydrocarbon group having 1 to 10 carbon atoms).

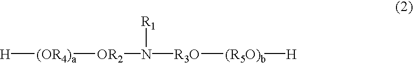

[wherein R₁ is a monovalent hydrocarbon group having 1 to 10 carbon atoms; R₂ and R₃ may be the same or different and are each a divalent hydrocarbon group having 1 to 10 carbon atoms; R₄ and R_may be the same or different and are each a divalent organic group having 1 to 10 carbon atoms; and a and b are each such an integer of 0 or more that the number-average molecular weight of the compound of the formula (2) becomes 300 to 10,000].

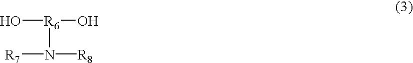

(wherein R₆ is a trivalent hydrocarbon group having 1 to 10 carbon atoms, and R₇ and R₈ may be the same or different and are each a monovalent hydrocarbon group having 1 to 10 carbon atoms).

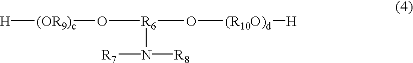

[wherein R₆ is a trivalent hydrocarbon group having 1 to 10 carbon atoms; R₇ and R₈ may be the same or different and are each a monovalent hydrocarbon group having 1 to 10 carbon atoms; R₉ and R₁₀ may be the same or different and are each a divalent organic group having 1 to 10 carbon atoms; and c and d are each such an integer of 0 or more that the number-average molecular weight of the compound of the formula (4) becomes 300 to 10,000].

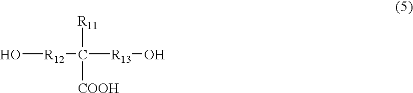

(wherein R₁₁ is a monovalent hydrocarbon group having 1 to 10 carbon atoms, and R₁₂ and R₁₃ may be the same or different and are each a divalent hydrocarbon group having 1 to 10 carbon atoms).

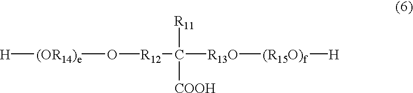

[wherein R₁₁ is a monovalent hydrocarbon group having 1 to 10 carbon atoms; R₁₂ and R₁₃ may be the same or different and are each a divalent hydrocarbon group having 1 to 10 carbon atoms; R₁₄ and R₁₅ may be the same or different and are each a divalent organic group having 1 to 10 carbon atoms; and e and f are each such an integer of 0 or more that the number-average molecular weight of the compound of the formula (6) becomes 300 to 10,000].

(4) A non-aqueous laminate adhesive comprising:

a tertiary amino group- and carboxyl group-containing polyurethane resin (B) obtained by reacting an active hydrogen group-containing compound comprising at least (a) one or more kinds of compounds selected from the group consisting of compounds represented by the following formulas (1), (2), (3) and (4) and (b) one or two kinds of compounds selected from the group consisting of compounds represented by the following formulas (5) and (6), with an organic polyisocyanate with the active hydrogen group being present in excess;

a polyisocyanate curing agent, and

a silane coupling agent represented by the following formula (7),

wherein the content of the tertiary amino group and the content of the carboxyl group in the tertiary amino group- and carboxyl group-containing polyurethane resin (B) are each 0.001 to 1 mmol/g.

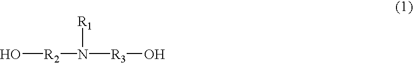

(wherein R₁ is a monovalent hydrocarbon group having 1 to 10 carbon atoms, and R₂ and R₃ may be the same or different and are each a divalent hydrocarbon group having 1 to 10 carbon atoms).

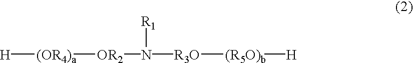

[wherein R₁ is a monovalent hydrocarbon group having 1 to 10 carbon atoms; R₂ and R₃ may be the same or different and are each a divalent hydrocarbon group having 1 to 10 carbon atoms; R₄ and R₁₅ may be the same or different and are each a divalent organic group having 1 to 10 carbon atoms; and a and b are each such an integer of 0 or more that the number-average molecular weight of the compound of the formula (2) becomes 300 to 10,000].

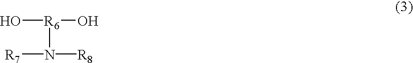

(wherein R₆ is a trivalent hydrocarbon group having 1 to 10 carbon atoms, and R₇ and R₈ may be the same or different and are each a monovalent hydrocarbon group having 1 to 10 carbon atoms).

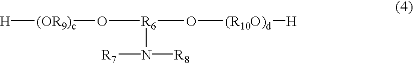

[wherein R₆ is a trivalent hydrocarbon group having 1 to 10 carbon atoms; R₇ and R₈ may be the same or different and are each a monovalent hydrocarbon group having 1 to 10 carbon atoms; R₉ and R₁₀ may be the same or different and are each a divalent organic group having 1 to 10 carbon atoms; and c and d are each such an integer of 0 or more that the number-average molecular weight of the compound of the formula (4) becomes 300 to 10,000].

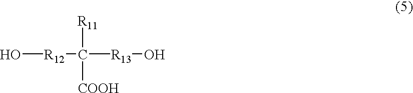

(wherein R₁₁ is a monovalent hydrocarbon group having 1 to 10 carbon atoms, and R₁₂ and R₁₃ may be the same or different and are each a divalent hydrocarbon group having 1 to 10 carbon atoms).

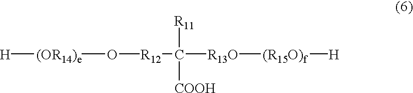

[wherein R₁₁ is a monovalent hydrocarbon group having 1 to 10 carbon atoms; R₁₂ and R₁₃ may be the same or different and are each a divalent hydrocarbon group having 1 to 10 carbon atoms; R₁₄ and R₁₅ may be the same or different and are each a divalent organic group having 1 to 10 carbon atoms; and e and f are each such an integer of 0 or more that the number-average molecular weight of the compound of the formula (6) becomes 300 to 10,000].

OCN—(CH₂)ₘ—Si(OR)₃ (7)

(wherein R is a methyl group or an ethyl group, and m is an integer of 1 to 5).

### DETAILED DESCRIPTION OF THE INVENTION

The present invention is described in detail below.

Description is made first on the tertiary amino group-containing polyurethane resin (A) and the tertiary amino group- and carboxyl group-containing polyurethane resin (B), both used in the present invention.

The polyurethane resin used in a laminate adhesive is required to have adhesivity to various kinds of plastic films or metal foils each used as a base material of a laminated film to be produced with the laminate adhesive; and the laminated film produced with the laminate adhesive containing the polyurethane resin is required to have flexibility, low-temperature resistance, heat resistance, etc.

In the present invention, the tertiary amino group-containing polyurethane resin (A) is obtained by reacting an active hydrogen group-containing compound comprising at least a tertiary amino group- and active hydrogen group-containing compound, with an organic polyisocyanate with the active hydrogen group being present in excess. Therefore, the tertiary amino group-containing polyurethane resin (A) has active hydrogen groups at molecular terminals. The number of the active hydrogen groups in the polyurethane resin (A) is, on an average, preferably 1 or more, particularly preferably 2 or more per molecule. When no active hydrogen group is present in the polyurethane resin (A), the polyurethane resin (A) is unable to react with a polyisocyanate curing agent and the resulting adhesive gives a laminated film low in adhesion strength, etc.

The tertiary amino group-containing polyurethane resin (A) must have tertiary amino group. The content of the tertiary amino group is 0.001 to 1 mmol/g, preferably 0.01 to 0.9 mmol/g, more preferably 0.03 to 0.8 mmol/g. When the content of the tertiary amino group is less than the above lower limit, the resulting adhesive tends to give a laminated film requiring a longer aging time. When the content is more than the above upper limit, the compound of the polyurethane resin (A) with a curing agent tends to have a shorter pot life.

The number-average molecular weight of the tertiary amino group-containing polyurethane resin (A) is preferably 3,000 to 60,000, particularly preferably 5,000 to 40,000. When the number-average molecular weight is less than the above lower limit, the resulting adhesive tends to have an insufficient adhesion strength. When the number-average molecular weight is more than the above upper limit, the resulting adhesive tends to have a high viscosity and, accordingly, lower workability in the application.

In the present invention, the tertiary amino group- and carboxyl group-containing polyurethane resin (B) is obtained by reacting an active hydrogen group-containing compound comprising at least a tertiary amino group- and active hydrogen group-containing compound and a carboxyl group- and active hydrogen group-containing compound, with an organic polyisocyanate with the active hydrogen group being present in excess. Therefore, the tertiary amino group- and carboxyl group-containing polyurethane resin (B) has active hydrogen groups at molecular terminals. The number of the active hydrogen groups in the polyurethane resin (B) is, on an average, preferably 1 or more, particularly preferably 2 or more per molecule. When no active hydrogen group is present in the polyurethane resin (B), the polyurethane resin (B) is unable to react with a polyisocyanate curing agent and the resulting adhesive gives a laminated film low in adhesion strength, etc.

The tertiary amino group- and carboxyl group-containing polyurethane resin (B) must have tertiary amino group and carboxyl group. The content of the tertiary amino group and the content of the carboxyl group are each 0.001 to 1 mmol/g, preferably 0.01 to 0.9 mmol/g, more preferably 0.03 to 0.8 mmol/g. When the content of the tertiary amino group is less than the above lower limit, the resulting adhesive tends to give a laminated film requiring a longer aging time. When the content is more than the above upper limit, the compound of the polyurethane resin (B) with a curing agent tends to have a shorter pot life. When the content of the carboxyl group is less than the above lower limit, the resulting adhesive is insufficient in adhesivity particularly to aluminum foil; and when the content is more than the above upper limit, the resulting adhesive tends to give a laminated film requiring a longer aging time.

In the tertiary amino group- and carboxyl group-containing polyurethane resin (B), the molar ratio of the tertiary amino group and the carboxyl group is preferably 1:9 to 6:4, more preferably 3:7 to 5:5. When the amount of the tertiary amino group is more than this ratio, the compound of the polyurethane resin (B) with a polyisocyanate curing agent tends to have a shorter pot life. When the amount of the tertiary amino group is less than the above ratio, the resulting adhesive tends to give a laminated film requiring a longer aging time.

The number-average molecular weight of the tertiary amino group- and carboxyl group-containing polyurethane resin (B) is preferably 3,000 to 60,000, particularly preferably 5,000 to 40,000. When the number-average molecular weight is less than the above lower limit, the resulting adhesive tends to have an insufficient adhesion strength. When the number-average molecular weight is more than the above upper limit, the resulting adhesive tends to have a higher viscosity and, accordingly, lower workability in the application.

In using the tertiary amino group-containing polyurethane resin (A) or the tertiary amino group- and carboxyl group-containing polyurethane resin (B) by dissolving it in an organic solvent, the solid content in the resulting resin solution is preferably 10 to 90% by weight, more preferably 15 to 85% by weight. Also, the viscosity of the resin solution is preferably 10,000 mPa·s or less, more preferably 8,000 mPa·s or less at 25° C.

The active hydrogen group-containing compound used for producing the tertiary amino group-containing polyurethane resin (A) includes one or more kinds of compounds selected form the group consisting of compounds represented by the following formulas (1), (2), (3) and (4); and, optionally, a high-molecular polyol having a number-average molecular weight of 300 to 10,000, substantially free from tertiary amino group or carboxyl group, and a chain extender having a molecular weight of less than 300, substantially free from tertiary amino group or carboxyl group. The active hydrogen group-containing compound used for producing the tertiary amino group- and carboxyl group-containing polyurethane resin (B) includes one or more kinds of compounds selected form the group consisting of compounds represented by the following formulas (1), (2), (3) and (4); one or two kinds of compounds selected form the group consisting of compounds represented by the following formulas (5) and (6); and, optionally, a high-molecular polyol having a number-average molecular weight of 300 to 10,000, substantially free from tertiary amino group or carboxyl group, and a chain extender having a molecular weight of less than 300, substantially free from tertiary amino group or carboxyl group.

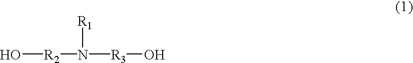

(wherein R₁ is a monovalent hydrocarbon group having 1 to 10 carbon atoms, and R₂ and R₃ may be the same or different and are each a divalent hydrocarbon group having 1 to 10 carbon atoms).

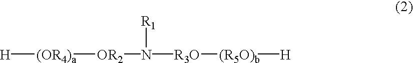

[wherein R₁ is a monovalent hydrocarbon group having 1 to 10 carbon atoms; R₂ and R₃ may be the same or different and are each a divalent hydrocarbon group having 1 to 10 carbon atoms; R₄ and R₅ may be the same or different and are each a divalent organic group having 1 to 10 carbon atoms; and a and b are each such an integer of 0 or more that the number-average molecular weight of the compound of the formula (2) becomes 300 to 10,000].

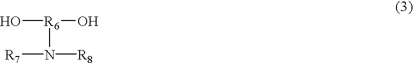

(wherein R₆ is a trivalent hydrocarbon group having 1 to 10 carbon atoms, and R₇ and R₈ may be the same or different and are each a monovalent hydrocarbon group having 1 to 10 carbon atoms).

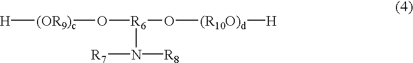

[wherein R₆ is a trivalent hydrocarbon group having 1 to 10 carbon atoms; R₇ and R₈ may be the same or different and are each a monovalent hydrocarbon group having 1 to 10 carbon atoms; R₉ and R₁₀ may be the same or different and are each a divalent organic group having 1 to 10 carbon atoms; and c and d are each such an integer of 0 or more that the number-average molecular weight of the compound of the formula (4) becomes 300 to 10,000].

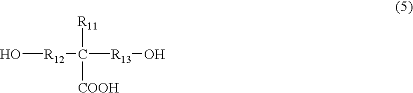

(wherein R₁₁ is a monovalent hydrocarbon group having 1 to 10 carbon atoms, and R₁₂ and R₁₃ may be the same or different and are each a divalent hydrocarbon group having 1 to 10 carbon atoms).

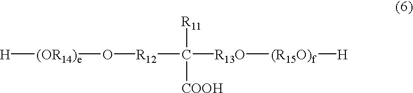

[wherein R₁₁ is a monovalent hydrocarbon group having 1 to 10 carbon atoms; R₁₂ and R₁₃ may be the same or different and are each a divalent hydrocarbon group having 1 to 10 carbon atoms; R₁₄ and R₁₅ may be the same or different and are each a divalent organic group having 1 to 10 carbon atoms; and e and f are each such an integer of 0 or more that the number-average molecular weight of the compound of the formula (6) becomes 300 to 10,000].

As the compound represented by the formula (1), there can be mentioned N-methyl-N,N-dimethylolamine, N-ethyl-N,N-dimethylolamine, N-propyl-N,N-dimethylolamine,

N-phenyl-N,N-dimethylolamine, N-methyl-N,N-diethanolamine,

N-ethyl-N,N-diethanolamine, N-propyl-N,N-diethanolamine,

N-phenyl-N,N-diethanolamine, N-methyl-N,N-dipropanolamine,

N-ethyl-N,N-dipropanolamine, N-propyl-N,N-dipropanolamine,

N-phenyl-N,N-dipropanolamine, etc. Preferred in the present invention are compounds of the formula (1) wherein R₁ is an alkyl group having 1 to 6 carbon atoms and R₂ and R₃ are each an alkylene group having 1 to 6 carbon atoms.

As the compound represented by the formula (2), there can be mentioned compounds obtained by adding, to a compound represented by the formula (1), a cyclic ester (e.g. ε-caprolactone or γ-valerolactone) or an alkylene oxide (e.g. ethylene oxide or propylene oxide). Preferred in the present invention are compounds of the formula (2) wherein R₁ is an alkyl group having 1 to 6 carbon atoms, R₂ and R₃ are each an alkylene group having 1 to 6 carbon atoms, and R₄ and R₅ are each a group represented by the general formula —R′—CO— (R′ is an alkylene group having 1 to 10 carbon atoms). The number-average molecular weight of the compound represented by the formula (2) is preferably 500 to 5,000.

As the compound represented by the formula (3), there can be mentioned 2-(N,N-dimethylamino)-1,3-propanediol, 2-(N,N-diethylamino)-1,3-propanediol, 2-(N-methyl-N-ethylamino)-1,3-propanediol, 5-(N,N-dimethylaminobenzene)-1,3-dimethanol, 2-(N,N-dimethylaminomethyl)-1,3-propanediol, etc. Preferred in the present invention are compounds of the formula (3) wherein R₆ is a trivalent saturated aliphatic hydrocarbon group having 1 to 6 carbon atoms, and R₇ and R₈ are each an alkyl group having 1 to 6 carbon atoms.

As the compound represented by the formula (4), there can be mentioned compounds obtained by adding, to a compound represented by the formula (3), a cyclic ester (e.g. ε-caprolactone or γ-valerolactone) or an alkylene oxide (e.g. ethylene oxide or propylene oxide). Preferred in the present invention are compounds of the formula (4) wherein R₆ is a trivalent saturated aliphatic hydrocarbon group having 1 to 6 carbon atoms, R₇ and R₈ are each an alkyl group having 1 to 6 carbon atoms, and R₁ and R₁₀ are each a group represented by the general formula —R′—CO— (R′ is an alkylene group having 1 to 10 carbon atoms). The number-average molecular weight of the compound represented by the formula (4) is preferably 500 to 5,000.

As the compound represented by the general formula (5), there can be mentioned, 2,2-dimethylolpropionic acid,

2,2-dimethylolbutanoic acid, 2-hydroxymethyl-2-hydroxyethylpropionic acid, 2-hydroxymethyl-2-hydroxyethylbutanoic acid, etc. Preferred in the present invention are compounds of the formula (5) wherein R₁₁ is an alkyl group having 1 to 6 carbon atoms, and R₁₂ and R₁₃ are each an alkylene group having 1 to 6 carbon atoms.

As the compound represented by the formula (6), there can be mentioned compounds obtained by adding, to a compound represented by the formula (5), a cyclic ester (e.g. ε-caprolactone or γ-valerolactone) or an alkylene oxide (e.g. ethylene oxide or propylene oxide). Preferred in the present invention are compounds of the formula (6) wherein R₁₁ is an alkyl group having 1 to 6 carbon atoms, R₁₂ and R₁₃ are each an alkylene group having 1 to 6 carbon atoms, and R₁₄ and R₁₅ are each a group represented by the general formula —R′—CO— (R′ is an alkylene group having 1 to 10 carbon atoms). The number-average molecular weight of the compound represented by the formula (6) is preferably 500 to 5,000.

As the high-molecular polyol substantially free from tertiary amino group or carboxyl group, there can be mentioned a polyester polyol, a polyester amide polyol, a polycarbonate polyol, a polyether polyol, a polyolefin polyol, an animal- or plant-derived polyol, copolyols thereof, etc. These high-molecular polyols may be used singly or in admixture of two or more kinds. The number-average molecular weight of the high-molecular polyol is preferably 300 to 10,000, more preferably 500 to 5,000.

As the polyester polyol and the polyester amide polyol, there can be mentioned those compounds obtained by subjecting the following two kinds of compounds to a dehydration-condensation reaction:

at least one kind of compound selected from polycarboxylic acids (e.g. succinic acid, adipic acid, sebacic acid, azelaic acid, terephthalic acid, isophthalic acid, orthophthalic acid, hexahydroterephthalic acid, hexahydroisophthalic acid, hexahydroorthophthalic acid, naphthalenedicarboxylic acid and trimellitic acid), acid esters, acid anhydrides, etc., and

at least one kind of compound selected from low-molecular polyols (e.g. ethylene glycol, 1,2-propanediol, 1,3-propanediol, 1,2-butanediol, 1,3-butanediol, 1,4-butanediol, 1,5-pentanediol, 2-methyl-1,5-pentanediol, 3-methyl-1,5-pentanediol, 1,6-hexanediol, 3-methyl-1,5-pentanediol, neopentyl glycol, 1,8-octanediol, 1,9-nonanediol, 2,2-diethyl-1,3-propanediol, 2-n-butyl-2-ethyl-1,3-propanediol, 2,2,4-trimethyl-1,3-pentanediol, 2-ethyl-1,3-hexanediol, 2-n-hexadecane-1,2-ethylene glycol, 2-n-eicosane-1,2-ethylene glycol, 2-n-octacosane-1,2-ethylene glycol, diethylene glycol, dipropylene glycol, 1,4-cyclohexanedimethanol, ethylene oxide or propylene oxide adduct of bisphenol A, hydrogenated bisphenol A, 3-hydroxy-2,2-dimethylpropyl-3-hydroxy-2,2-dimethylpropionate, trimethylolpropane, glycerine and pentaerythritol). There can also be mentioned lactone type polyester polyols obtained by ring-opening polymerization of a cyclic ester (lactone) monomer such as ε-caprolactone, γ-valerolactone or the like using a low-molecular polyol as a starting material.

As the polycarbonate polyol, there can be mentioned those compounds obtained by an alcohol-eliminating or phenol-eliminating reaction between (a) the above-mentioned low-molecular polyol used in synthesis of the above-mentioned polyester polyol and (b) diethylene carbonate, dimethyl carbonate, diethyl carbonate, diphenyl carbonate or the like.

As the polyether polyol, there can be mentioned a polyethylene glycol, a polypropylene glycol and a polytetramethylene ether glycol, etc. all obtained by ring-opening polymerization or copolymerization of ethylene oxide, propylene oxide, tetrahydrofuran or the like using, as a starting material, the above-mentioned low-molecular polyol, low-molecular polyamine or low-molecular aminoalcohol used in synthesis of the above-mentioned polyester polyol; and polyester ether polyols produced using, as a starting material, the above-mentioned polyester polyol or polycarbonate polyol.

As the polyolefin polyol, there can be mentioned a hydroxyl group-containing polybutadiene, a hydrogenated hydroxyl group-containing polybutadiene, a hydroxyl group-containing polyisoprene, a hydrogenated hydroxyl group-containing polyisoprene, a hydroxyl group-containing chlorinated polypropylene, a hydroxyl group-containing chlorinated polyethylene, etc.

As the animal- or plant-derived polyol, there can be mentioned a castor oil-derived polyol, a silk fibroin, etc.

Incidentally, it is possible to use, as part of the active hydrogen group-containing compound, a urea resin, a melamine resin, an epoxy resin, a polyester resin, an acrylic resin, a polyvinyl alcohol, a rosin resin, etc. as long as each of these substances has, in the molecule, at least one functional group (e.g. active hydrogen group) capable of reacting with isocyanate group.

The high-molecular polyol is preferably a polyester polyol obtained by using terephthalic acid, isophthalic acid, adipic acid, azelaic acid or sebacic acid, when there is considered the adhesivity of the resulting adhesive to the base film of a laminated film to be produced.

As the chain extender, there can be mentioned a low-molecular polyol which is a raw material of the above-mentioned polyester polyol, water, urea, etc.

As the organic polyisocyanate used for production of the tertiary amino group-containing polyurethane resin (A) or the tertiary amino group- and carboxyl group-containing polyurethane resin (B), there can be mentioned, for example, polyisocyanates such as aromatic diisocyanates (e.g. 2,4-tolylene diisocyanate, 2,6-tolylene diisocyanate, xylylene-1,4-diisocyanate, xylylene-1,3-diisocyanate, 4,4′-diphenylmethane diisocyanate, 2,4′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′,-diphenylpropane diisocyanate, m-phenylene diisocyanate, p-phenylene diisocyanate, naphthylene-1,4-diisocyanate, naphthylene-1,5-diisocyanate and 3,3′-dimethoxydiphenyl-4,4′-diisocyanate), aromatic polyisocyanates (e.g. polyphenylene polymethylene polyisocyanate and crude tolylene diisocyanate), aliphatic diisocyanates (e.g. tetramethylene diisocyanate, hexamethylene diisocyanate, decamethylene diisocyanate and lysine diisocyanate), alicyclic diisocyanates (e.g. isophorone diisocyanate, hydrogenated tolylene diisocyanate, hydrogenated xylylene diisocyanate, hydrogenated diphenylmethane diisocyanate and tetramethylxylylene diisocyanate) and the like; biuret bond-containing polyisocyanates derived from the above polyisocyanates; uretdione bond-containing polyisocyanates derived from the above polyisocyanates; isocyanurate bond-containing polyisocyanates derived from the above polyisocyanates; uretdione bond- and isocyanurate bond-containing polyisocyanates derived from the above polyisocyanates; uretonimine bond-containing polyisocyanates derived form the above polyisocyanates; and polyisocyanate adducts obtained by a reaction between (a) a polyol or the like, having at least two functionalities and (b) one of the above polyisocyanates or the above modified polyisocyanates.

The reactor used for production of the polyurethane resin (A) or the polyurethane resin (B) can be any apparatus as long as it can conduct the above reaction. There can be mentioned, for example, mixing and kneading apparatuses such as reactor with stirrer, kneader, single- or multi-screw extruder and reactor, and the like. In order to accelerate the reaction, it is possible to use a metal catalyst (e.g. dioctyl tin dilaurate), a tertiary amine catalyst (e.g. triethylamine) or other catalyst, all ordinarily used in production of a polyurethane or a polyurea.

The polyurethane resin (A) or (B) is used in a non-aqueous form, that is, in a non-solvent state or as a solution dissolved in an organic solvent. Use as a solution of the resin (A) or (B) dissolved in an organic solvent is preferred. Adhesives using an aqueous polyurethane resin have problems such as (1) their wettability to a base film in their coating thereon is poor and (2) a large amount of heat energy is required in drying the coated adhesive.

The organic solvent can be any organic solvent as long as it is inert to isocyanate group. There can be mentioned, for example, aromatic hydrocarbon type solvents such as toluene, xylene and the like; ester type solvents such as ethyl acetate, butyl acetate and the like; ketone type solvents such as methyl ethyl ketone, cyclohexanone and the like; glycol ether ester type solvents such as ethylene glycol ethyl ether acetate, propylene glycol methyl ether acetate, ethyl 3-ethoxypropionate and the like; ether type solvents such as tetrahydrofuran, dioxane and the like; and polar solvents such as dimethylformamide, dimethylacetamide, N-methylpyrrolidone, furfural and the like. These solvents can be used singly or in admixture of two or more kinds. It is also possible to mix and react individual components in the above-mentioned compounding ranges in the presence of the above solvent, preferably at 100° C. or lower to produce the resin (A) or (B).

To the polyurethane resin (A) or (B) may be added as necessary additives such as pigment, dye, thixotropic agent, antioxidant, ultraviolet absorber, antifoaming agent, thickener, dispersing agent, surfactant, fungicide, microbicide, antiseptic agent, catalyst, filler and the like.

As the polyisocyanate curing agent used in the present invention, there can be mentioned, for example, above-mentioned organic polyisocyanates used in production of the polyurethane resin (A) or (B). As preferred organic polyisocyanates, there can be mentioned modified polyisocyanates such as Coronate (registered trademark)-L, Coronate-3041, Coronate-HL and Coronate-HX all produced by Nipon Polyurethane Industry Co., Ltd. Particularly preferred organic polyisocyanates are modified polyisocyanates derived from hexamethylene diisocyanate, i.e. Coronate-HL and Coronate-HX produced by Nipon Polyurethane Industry Co., Ltd.

The polyurethane resin (A) or (B) and the polyisocyanate curing agent are compounded in such proportions that the molar ratio of the total active hydrogen groups in the polyurethane resin (A) or (B) and the total isocyanate groups in the polyisocyanate curing agent becomes preferably 1:20 to 20:1, more preferably 1:15 to 15:1. When the molar ratio is outside of the above range, it is difficult to obtain a sufficient adhesion strength.

In the non-aqueous laminate adhesive of the present invention, it is preferred to use a silane coupling agent represented by the following formula (7), because the adhesion strength of the adhesive is sufficient even after a severe retort treatment:

OCN—(CH₂)ₘ—Si(OR)₃ (7)

(wherein R is a methyl group or an ethyl group, and m is an integer of 1 to 5).

As such a silane coupling agent, there can be mentioned γ-isocyanatopropyltrimethoxysilane, γ-isocyanatopropyltriethoxysilane, etc.

Having functional groups of —NCO and Si—OR (R is a methyl group or an ethyl group), the silane coupling agent does not react with the polyisocyanate curing agent under ordinary storage conditions. Therefore, when the polyisocyanate curing agent and the silane coupling agent are mixed and used under ordinary conditions, they have good storage stability.

When the polyisocyanate curing agent is compounded with the silane coupling agent and used, the amount of the silane coupling agent compounded is preferably 10% by weight or less, more preferably 8% by weight or less of the polyisocyanate curing agent. When the amount of the silane coupling agent compounded is too large, the resulting adhesive is low in adhesivity and the workability of lamination for production of laminated film is low. The above amount of the silane coupling agent compounded was calculated in view of, for example, the area of base film to be coated with silane coupling agent, the coating efficiency of silane coupling agent, and the adhesivity of resulting adhesive.

The non-aqueous laminate adhesive of the present invention is most appropriately used in production of a laminated film using (1) a plastic film made of a stretched polypropylene, a non-stretched polypropylene, a polyester, a nylon, a low-density polyethylene, a high-density polyethylene, an ethylene-vinyl acetate copolymer, a polyvinyl alcohol, an ethylene-vinyl alcohol copolymer, a polystyrene, a polycarbonate, a polyvinylidene chloride, a polyvinyl chloride or the like, (2) a metal foil made of aluminum, copper or the like, (3) a paper, or (4) a film obtained by applying, to the above plastic film, metal foil or paper, polymer coating, alumina vapor deposition, silica vapor deposition or the like.

Preferably, the above film, foil and paper is subjected to an appropriate surface treatment (e.g. corona discharging) before lamination because the surface treatment can enhance the adhesivity between films, foils or papers.

The conditions for lamination using the non-aqueous laminate adhesive of the present invention are preferably 10 to 180° C. and 0.1 to 1 MPa, more preferably 20 to 150° C. and 0.2 to 0.8 MPa.

The non-aqueous laminate adhesive of the present invention can be applied by a known lamination method such as dry lamination, hot-melt lamination, extrusion lamination or the like. The laminated film is subjected to aging to complete the curing reaction.

By such a method, two or more films are laminated to obtain a laminated film.

The conditions for aging after lamination using the non-aqueous laminate adhesive of the present invention are preferably 20 to 70° C. and 10 to 60 hours, more preferably 25 to 50° C. and 50 hours. Conventional laminate adhesives have required, for the aging, such a temperature and 72 hours or more.

As described above, the non-aqueous laminate adhesive of the present invention has a short aging time, a long pot life and good storage stability, which have been unachievable with conventional laminate adhesives.

### DESCRIPTION OF PREFERRED EMBODIMENTS

Next, the present invention is described in detail by way of Examples. However, the present invention is in no way restricted by these Examples. In Examples and Comparative Examples, % refers to % by weight unless otherwise specified.

[Production of Tertiary Amino Group-Containing Polyurethane Resins]

### EXAMPLE 1

400 g of a polyol A, 50 g of a polyol B and 333 g of ethyl acetate were fed into a 2-liter reactor provided with a stirrer, a thermometer, a nitrogen gas-introducing tube and a reflux condenser. The polyols A and B were dissolved in ethyl acetate at 60° C. Thereinto were fed 50 g of MDI and 0.1 g of DOTDL and a reaction was allowed to take place at 70° C. for 4 hours. At a timing when the disappearance of the absorption peak of isocyanate group was confirmed by IR absorption analysis, 167 g of ethyl acetate was added for dilution, whereby a polyurethane resin solution PU-1 was obtained.

### EXAMPLE 2

463 g of a polyol A, 0.3 g of MDEA and 125 g of ethyl acetate were fed into the same reactor as used in Example 1. The polyol A and MDEA were dissolved in ethyl acetate at 60° C. Thereinto were fed 36 g of HDI and 0.1 g of DOTDL and a reaction was allowed to take place at 70° C. for 5 hours. At a timing when the disappearance of the absorption peak of isocyanate group was confirmed by IR absorption analysis, 375 g of ethyl acetate was added for dilution, whereby a polyurethane resin solution PU-2 was obtained.

### EXAMPLE 3

457 g of a polyol A, 2.4 g of MDEA and 125 g of ethyl acetate were fed into the same reactor as used in Example 1. The polyol A and MDEA were dissolved in ethyl acetate at 60° C. Thereinto were fed 41 g of HDI and 0.1 g of DOTDL and a reaction was allowed to take place at 70° C. for 5 hours. At a timing when the disappearance of the absorption peak of isocyanate group was confirmed by IR absorption analysis, 375 g of ethyl acetate was added for dilution, whereby a polyurethane resin solution PU-3 was obtained.

### EXAMPLE 4

458 g of a polyol A, 3.0 g of MDEA and 125 g of ethyl acetate were fed into the same reactor as used in Example 1. The polyol A and MDEA were dissolved in ethyl acetate at 60° C. Thereinto were fed 39 g of HDI and 0.1 g of DOTDL and a reaction was allowed to take place at 70° C. for 5 hours. At a timing when the disappearance of the absorption peak of isocyanate group was confirmed by IR absorption analysis, 375 g of ethyl acetate was added for dilution, whereby a polyurethane resin solution PU-4 was obtained.

### EXAMPLE 5

370 g of a polyol A, 48 g of MDEA and 333 g of ethyl acetate were fed into the same reactor as used in Example 1. The polyol A and MDEA were dissolved in ethyl acetate at 60° C. Thereinto were fed 82 g of TDI and 0.1 g of DOTDL and a reaction was allowed to take place at 70° C. for 5 hours. At a timing when the disappearance of the absorption peak of isocyanate group was confirmed by IR absorption analysis, 167 g of ethyl acetate was added for dilution, whereby a polyurethane resin solution PU-5 was obtained.

### EXAMPLE 6

443 g of a polyol A, 4.4 g of DEAPD and 125 g of ethyl acetate were fed into the same reactor as used in Example 1. The polyol A and DEAPD were dissolved in ethyl acetate at 60° C. Thereinto were fed 52 g of IPDI and 0.1 g of DOTDL and a reaction was allowed to take place at 70° C. for 8 hours. At a timing when the disappearance of the absorption peak of isocyanate group was confirmed by IR absorption analysis, 375 g of ethyl acetate was added for dilution, whereby a polyurethane resin solution PU-6 was obtained.

### EXAMPLE 7

400 g of a polyol A, 50 g of a polyol C and 333 g of ethyl acetate were fed into the same reactor as used in Example 1. The polyols A and C were dissolved in ethyl acetate at 60° C. Thereinto were fed 50 g of MDI and 0.1 g of DOTDL and a reaction was allowed to take place at 70° C. for 4 hours. At a timing when the disappearance of the absorption peak of isocyanate group was confirmed by IR absorption analysis, 167 g of ethyl acetate was added for dilution, whereby a polyurethane resin solution PU-7 was obtained.

### COMPARATIVE EXAMPLE 1

449 g of a polyol A and 333 g of ethyl acetate were fed into the same reactor as used in Example 1, and the polyol A was dissolved in ethyl acetate at 60° C. Thereinto were fed 48 g of MDI and 0.1 g of DOTDL and a reaction was allowed to take place at 70° C. for 4 hours. At a timing when the disappearance of the absorption peak of isocyanate group was confirmed by IR absorption analysis, 167 g of ethyl acetate was added for dilution. Then, 1.0 g of A-1310 and 2.5 g of TEA were fed, whereby a polyurethane resin solution PU-8 was obtained.

### COMPARATIVE EXAMPLE 2

469 g of a polyol A and 125 g of ethyl acetate were fed into the same reactor as used in Example 1, and the polyol A was dissolved in ethyl acetate at 60° C. Thereinto were fed 30 g of HDI and 0.1 g of DOTDL and a reaction was allowed to take place at 70° C. for 5 hours. At a timing when the disappearance of the absorption peak of isocyanate group was confirmed by IR absorption analysis, 375 g of ethyl acetate was added for dilution, whereby a polyurethane resin solution PU-9 was obtained.

### COMPARATIVE EXAMPLE 3

278 g of a polyol A, 71 g of MDEA and 125 g of ethyl acetate were fed into the same reactor as used in Example 1, and the polyol A and MDEA were dissolved in ethyl acetate at 60° C. Thereinto were fed 148 g of MDI and 0.1 g of DOTDL and a reaction was allowed to take place at 70° C. for 4 hours. At a timing when the disappearance of the absorption peak of isocyanate group was confirmed by IR absorption analysis, 375 g of ethyl acetate was added for dilution, whereby a polyurethane resin solution PU-10 was obtained.

### COMPARATIVE EXAMPLE 4

459 g of a polyol A, 3.1 g of MDEA and 125 g of ethyl acetate were fed into the same reactor as used in Example 1, and the polyol A and MDEA were dissolved in ethyl acetate at 60° C. Thereinto were fed 38 g of HDI and 0.1 g of DOTDL and a reaction was allowed to take place at 70° C. for 5 hours. At a timing when the disappearance of the absorption peak of isocyanate group was confirmed by IR absorption analysis, 375 g of ethyl acetate was added for dilution. Then, 0.4 g of A-187 was fed, whereby a polyurethane resin solution PU-11 was obtained.

[Production of Tertiary Amino Group- and Carboxyl Group-Containing Polyurethane Resins]

### EXAMPLE 8

448.1 g of a polyol A, 2.4 g of MDEA, 4.4 g of DMBA and 125 g of ethyl acetate were fed into the same reactor as used in Example 1, and the polyol A, MDEA and DMBA were dissolved in ethyl acetate at 60° C. Thereinto were fed 49.7 g of IPDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution, whereby a polyurethane resin solution PU-12 was obtained.

### EXAMPLE 9

423.9 g of a polyol B, 2.9 g of DEAPD, 4.4 g of DMBA and 125 g of ethyl acetate were fed into the same reactor as used in Example 1, and the polyol B, DEAPD and DMBA were dissolved in ethyl acetate at 60° C. Thereinto were fed 71.2 g of HDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution, whereby a polyurethane resin solution PU-13 was obtained.

### EXAMPLE 10

393.1 g of a polyol B, 20.0 g of a polyol C, 8.9 g of DMBA and 125 g of ethyl acetate were fed into the same reactor as used in Example 1, and the polyol B, polyol C and DMBA were dissolved in ethyl acetate at 60° C. Thereinto were fed 87.3 g of IPDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution, whereby a polyurethane resin solution PU-14 was obtained.

### EXAMPLE 11

358.7 g of a polyol A, 11.9 g of MDEA, 100.0 g of a polyol E and 333 g of ethyl acetate were fed into the same reactor as used in Example 1, and the polyol A, MDEA and polyol C were dissolved in ethyl acetate at 60° C. Thereinto were fed 31.2 g of TDI and 0.1 g of DOTDL and a reaction was allowed to take place at 70° C. for 5 hours. At a timing when the disappearance of the absorption peak of isocyanate group was confirmed by IR absorption analysis, 167 g of ethyl acetate was added for dilution, whereby a polyurethane resin solution PU-15 was obtained.

### EXAMPLE 12

265.2 g of a polyol A, 7.3 g of DEAPD, 200.0 g of a polyol E and 125 g of ethyl acetate were fed into the same reactor as used in Example 1, and the polyol A, DEAPD and polyol E were dissolved in ethyl acetate at 60° C. Thereinto were fed 29.4 g of IPDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution, whereby a polyurethane resin solution PU-16 was obtained.

### EXAMPLE 13

440.5 g of a polyol A, 2.3 g of NPG, 5.0 g of a polyol D, 10.0 g of a polyol E and 333 g of ethyl acetate were fed into the same reactor as used in Example 1, and the polyol A, NPG, polyol D and polyol E were dissolved in ethyl acetate at 60° C. Thereinto were fed 55.1 g of MDI and 0.1 g of DOTDL and a reaction was allowed to take place at 70° C. for 5 hours. At a timing when the disappearance of the absorption peak of isocyanate group was confirmed by IR absorption analysis, 167 g of ethyl acetate was added for dilution, whereby a polyurethane resin solution PU-17 was obtained.

### EXAMPLE 14

444.1 g of a polyol A, 1.2 g of MDEA, 1.5 g of DEAPD, 4.4 g of DMBA and 125 g of ethyl acetate were fed into the same reactor as used in Example 1, and the polyol A, MDEA, DEAPD and DMBA were dissolved in ethyl acetate at 60° C. Thereinto were fed 49.3 g of IPDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution, whereby a polyurethane resin solution PU-18 was obtained.

### COMPARATIVE EXAMPLE 5

460.6 g of a polyol A, 4.4 g of DMBA and 125 g of ethyl acetate were fed into the same reactor as used in Example 1, and the polyol A and DMBA were dissolved in ethyl acetate at 60° C. Thereinto were fed 38.7 g of HDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution, whereby a polyurethane resin solution PU-19 was obtained.

### COMPARATIVE EXAMPLE 6

358.3 g of a polyol A, 23.8 g of MDEA, 88.8 g of DMBA and 125 g of ethyl acetate were fed into the same reactor as used in Example 1, and the polyol A, MDEA and DMBA were dissolved in ethyl acetate at 60° C. Thereinto were fed 30.1 g of HDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution, whereby a polyurethane resin solution PU-20 was obtained.

### COMPARATIVE EXAMPLE 7

355.3 g of a polyol A, 71.4 g of MDEA, 44.4 g of DMBA and 125 g of ethyl acetate were fed into the same reactor as used in Example 1, and the polyol A, MDEA and DMBA were dissolved in ethyl acetate at 60° C. Thereinto were fed 29.8 g of HDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution, whereby a polyurethane resin solution PU-21 was obtained.

### COMPARATIVE EXAMPLE 8

465.1 g of a polyol A and 125 g of ethyl acetate were fed into the same reactor as used in Example 1, and the polyol A was dissolved in ethyl acetate at 60° C. Thereinto were fed 39.1 g of HDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution, whereby a polyurethane resin solution PU-22 was obtained.

### COMPARATIVE EXAMPLE 9

460.6 g of a polyol A, 4.4 g of DMBA and 125 g of ethyl acetate were fed into the same reactor as used in Example 1, and the polyol A and DMBA were dissolved in ethyl acetate at 60° C. Thereinto were fed 38.7 g of HDI and 0.1 g of DOTDL and a reaction was allowed to take place at 70° C. for 6 hours. At a timing when the disappearance of the absorption peak of isocyanate group was confirmed by IR absorption analysis, 375 g of ethyl acetate was added for dilution. Then, the resulting solution was cooled to 50° C. or lower and 1.5 g of TEA was added to give rise to neutralization at 40 to 50° C. for 1 hour, whereby a polyurethane resin solution PU-23 was obtained.

[Storage Stability Test]

Each of PU-1 to PU-23 was placed in a 200-ml sample bottle. The bottle was sealed and kept in a thermostat water bath of 25° C. for 24 hours. Then, the bottle was taken out of the bath and the contents of the sample bottle were measured for viscosity in an atmosphere of 25° C.×50% R.H., using a B type viscometer (a product of Shibaura System K.K.). Thereafter, the sample bottle was resealed and stored at 40° C. for 3 months, and the contents of the sample bottle were measured for viscosity in the same manner as above. The results are shown in Tables 1 to 4.

TABLE 1

| | Examples | | | | | | |
|---|---|---|---|---|---|---|---|
| | 1 | 2 | 3 | 4 | 5 | 6 | 7 |
| High-molecular polyol (g) | 400 | 463 | 457 | 458 | 370 | 443 | 400 |
| Polyol A | | | | | | | |
| Tertiary amino group- and | | | | | | | |
| active hydrogen group- | | | | | | | |
| containing compound (g) | | | | | | | |
| Polyol B | 50 | | | | | | |
| Polyol C | | | | | | | 50 |
| MDEA | | 0.3 | 2.4 | 3.0 | 48 | | |
| DEAPD | | | | | | 4.4 | |
| Organic polyisocyanate (g) | | | | | | | |
| MDI | 50 | | | | | | 50 |
| HDI | | 36 | 41 | 39 | | | |
| TDI | | | | | 82 | | |
| IPDI | | | | | | 52 | |
| Catalyst (g) | 0.1 | 0.1 | 0.1 | 0.1 | 0.1 | 0.1 | 0.1 |
| DOTDL | | | | | | | |
| Organic solvent (g) | 500 | 500 | 500 | 500 | 500 | 500 | 500 |
| Ethyl acetate | | | | | | | |
| Polyurethane resin solution | PU-1 | PU-2 | PU-3 | PU-4 | PU-5 | PU-6 | PU-7 |
| Tertiary amino group | 0.1 | 0.005 | 0.04 | 0.05 | 0.8 | 0.06 | 0.1 |
| content (mmol/g) | | | | | | | |
| Solid content (%) | 50.1 | 50.0 | 50.2 | 49.8 | 50.1 | 50.1 | 50.0 |
| Viscosity (mPa · s/25° C.) | 1590 | 1000 | 3300 | 1070 | 550 | 1200 | 1570 |
| Number-average molecular | 19000 | 18000 | 35000 | 20000 | 7000 | 21000 | 19000 |
| weight | | | | | | | |
| Storage stability | | | | | | | |
| Viscosity after storage | 1550 | 940 | 3210 | 1020 | 510 | 1130 | 1540 |
| (mPa · s/25° C.) | | | | | | | |
| Viscosity retention (%) | 97.5 | 94.0 | 97.3 | 95.3 | 92.7 | 94.2 | 98.1 |

TABLE 2

| | Comparative Examples | | | |
|---|---|---|---|---|
| | 1 | 2 | 3 | 4 |
| High-molecular polyol (g) | 449 | 469 | 278 | 459 |
| Polyol A | | | | |
| Tertiary amino group- and | | | 71 | 3.1 |
| active hydrogen group- | | | | |
| containing compound (g) | | | | |
| MDEA | | | | |
| Tertiary amino group- | 2.5 | | | |
| containing compound (g) | | | | |
| TEA | | | | |
| Organic polyisocyanate (g) | | | | |
| MDI | 48 | | 148 | |
| HDI | | 30 | | 38 |
| Catalyst (g) | 0.1 | 0.1 | 0.1 | 0.1 |
| DOTDL | | | | |
| Silane coupling agent (g) | | | | |
| A-1310 | 1.0 | | | |
| A-187 | | | | 0.4 |
| Organic solvent (g) | 500 | 500 | 500 | 500 |
| Ethyl acetate | | | | |
| Polyurethane resin solution | PU-8 | PU-9 | PU-10 | PU-11 |
| Tertiary amino group | 0.05 | | 1.2 | 0.05 |
| content (mmol/g) | | | | |
| Solid content (%) | 49.9 | 50.2 | 50.1 | 49.9 |
| Viscosity (mPa · s/25° C.) | 3000 | 620 | 980 | 1650 |
| Number-average molecular | 30000 | 8000 | 13000 | 20000 |
| weight | | | | |
| Storage stability | | | | |
| Viscosity after storage | 1400 | 650 | 950 | 3380 |
| (mPa · s/25° C.) | | | | |
| Viscosity retention (%) | 46.7 | 104.9 | 96.9 | 204.8 |

TABLE 3

| | Examples | | | | | | |
|---|---|---|---|---|---|---|---|
| | 8 | 9 | 10 | 11 | 12 | 13 | 14 |
| High-molecular polyol (g) | | | | | | | |
| Polyol A | 448.1 | | 358.7 | 265.2 | 440.5 | 444.1 | |
| Polyol B | | 423.9 | 393.1 | | | | |
| Chain extender (g) | | | | | | 2.3 | |
| NPG | | | | | | | |
| Tertiary amino group- and | | | | | | | |
| active hydrogen group- | | | | | | | |
| containing compound (g) | | | | | | | |
| MDEA | 2.4 | | | 11.9 | | | 1.2 |
| DEAPD | | 2.9 | | | 7.3 | | 1.5 |
| Polyol C | | | 20.0 | | | | |
| Polyol D | | | | | | 5.0 | |
| Carboxyl group- and active | | | | | | | |
| hydrogen group-containing | | | | | | | |
| compound (g) | | | | | | | |
| DMBA | 4.4 | 4.4 | 8.9 | | | | 4.4 |
| Polyol E | | | | 100.0 | 200.0 | 10.0 | |
| Organic polyisocyanate (g) | | | | | | | |
| IPDI | 49.7 | | 87.3 | | 29.4 | | 49.3 |
| HDI | | 71.2 | | | | | |
| TDI | | | | 31.2 | | | |
| MDI | | | | | | 55.1 | |
| Catalyst (g) | | | | | | | |
| DOTDL | 0.1 | 0.1 | 0.1 | 0.1 | 0.1 | 0.1 | 0.1 |
| Organic solvent (g) | 500 | 500 | 500 | 500 | 500 | 500 | 500 |
| Ethyl acetate | | | | | | | |
| Polyurethane resin solution | PU-12 | PU-13 | PU-14 | PU-15 | PU-16 | PU-17 | PU-18 |
| Tertiary amino group | 0.04 | 0.04 | 0.08 | 0.2 | 0.1 | 0.02 | 0.04 |
| content (mmol/g) | | | | | | | |
| Carboxyl group content | 0.06 | 0.06 | 0.12 | 0.4 | 0.8 | 0.04 | 0.06 |
| (mmol/g) | | | | | | | |
| Solid content (%) | 50.2 | 50.1 | 49.8 | 49.9 | 50.0 | 50.1 | 50.0 |
| Viscosity (mPa · s/25° C.) | 2200 | 2100 | 800 | 2000 | 1900 | 600 | 2000 |
| Number-average molecular | 21000 | 32000 | 11000 | 20000 | 16000 | 8000 | 20000 |
| weight | | | | | | | |
| Storage stability | | | | | | | |
| Viscosity after storage | 2250 | 2150 | 830 | 2050 | 1900 | 650 | 2070 |
| (mPa · s/25° C.) | | | | | | | |
| Viscosity retention (%) | 2.3 | 2.4 | 3.8 | 2.5 | 0.0 | 8.3 | 3.5 |

TABLE 4

| | Comparative Examples | | | | |
|---|---|---|---|---|---|
| | 5 | 6 | 7 | 8 | 9 |
| High-molecular polyol | 460.6 | 358.3 | 355.3 | 465.1 | 460.6 |
| (g) Polyol A | | | | | |
| Tertiary amino group- | | 23.8 | 71.4 | | |
| and active hydrogen | | | | | |
| group-containing | | | | | |
| compound (g) | | | | | |
| MDEA | | | | | |
| Carboxyl group- and | 4.4 | 88.8 | 44.4 | | 4.4 |
| active hydrogen group- | | | | | |
| containing compound (g) | | | | | |
| DMBA | | | | | |
| Organic polyisocyanate | 38.7 | 30.1 | 29.8 | 39.1 | 38.7 |
| (g) HDI | | | | | |
| Catalyst (g) | 0.1 | 0.1 | 0.1 | 0.1 | 0.1 |
| DOTDL | | | | | |
| Tertiary amino group- | | | | | 1.5 |
| containing compound (g) | | | | | |
| TEA | | | | | |
| Organic solvent (g) | 500 | 500 | 500 | 500 | 500 |
| Ethyl acetate | | | | | |
| Polyurethane resin | PU-19 | PU-20 | PU-21 | PU-22 | PU-23 |
| solution | | | | | |
| Tertiary amino group | | 0.4 | 1.2 | | 0.03 |
| content (mmol/g) | | | | | |
| Carboxyl group content | 0.06 | 1.2 | 0.6 | | 0.06 |
| (mmol/g) | | | | | |
| Solid content (%) | 50.1 | 50.3 | 49.8 | 49.8 | 50.2 |
| Viscosity (mPa · s/ | 1900 | 3200 | 2800 | 1480 | 1500 |
| 25° C.) | | | | | |
| Number-average | 20000 | 21000 | 19000 | 18000 | 22000 |
| molecular weight | | | | | |
| Storage stability | | | | | |
| Viscosity after storage | 1950 | 3200 | 2830 | 1500 | 900 |
| (mPa · s/25° C.) | | | | | |
| Viscosity retention (%) | 2.6 | 0.0 | 1.1 | 1.4 | 40.0 |

In Examples 1 to 14, Comparative Examples 1 to 9 and Tables 1 to 4,

Polyol A: a polyester diol obtained from ethylene glycol/neopentyl glycol=1/1 (molar ratio) and sebacic acid/isophthalic acid=1/1 (molar ratio); number-average molecular weight=2,000

Polyol B: a polyester diol obtained from ethylene glycol/neopentyl glycol=1/1 (molar ratio) and sebacic acid/isophthalic acid=1/1 (molar ratio); number-average molecular weight=1,000

Polyol C: a tertiary amino group-containing lactone type polyol obtained by adding ε-caprolactone to N-methyl-N,N-diethanolamine; number-average molecular weight=500

Polyol D: a tertiary amino group-containing lactone type polyol obtained by adding ε-caprolactone to 2-(N,N-dimethylamino)-1,3-propanediol; number-average molecular weight=500

Polyol E: a carboxyl gorup-containing diol obtained by adding ε-caprolactone to the methylol group of dimethylolpropionic acid; number-average molecular weight=500

NPG: neopentyl glycol

MDEA: N-methyl-N,N-diethanolamine

DEAPD: 2-(N,N-diethylamino)-1,3-propanediol

DMBA: 2,2-dimethylolbutanoic acid

IPDI: isophorone diisocyanate

HDI: hexamethylene diisocyanate

TDI: 2,4-tolylene diisocyanate

MDI: 4,4′-diphenylmethane diisocyanate

DOTDL: dioctyltin dilaurate

TEA: triethylamine

A-187: a silane coupling agent produced by Nippon Unicar Company Limited, γ-glycidoxypropyltrimethoxysialne

A-1310: a silane coupling agent produced by Nippon Unicar Company Limited, γ-isocyanatopropyltriethoxysilane

All of the polyurethane resin solutions of Examples 1 to 7 showed a viscosity retention [(a viscosity after 24 hours at 25° C.)÷(a viscosity after 3 months at 40° C.)×100], of about 90 to 100%. All of the polyurethane resin solutions of Examples 8 to 14 showed a viscosity increase [(a viscosity after 3 months at 40° C.−a viscosity after 24 hours at 25° C.)÷(a viscosity after 24 hours at 25° C.)×100], of less than 10. Thus, the polyurethane resin solutions of Examples 1 to 14 showed good storage stability. In contrast, the polyurethane resin solutions of Comparative Examples 1 and 9 showed a large reduction in viscosity. This is considered to be because the polyurethane resins were hydrolyzed by free tertiary amine. The polyurethane resin solution of Comparative Example 4 showed a large increase in viscosity. This is considered to be because the silane coupling agent used caused a crosslinking reaction.

[Compounding of Curing Agents]

### PREPARATION EXAMPLES 1 to 6

6 kinds of polyisocyanate curing agents CA-1 to CA-6 were compounded according to the formulations shown in Table 5. They were stored in a cold dark place for 1 month to examine their storage stabilities. The results are shown in Table 5.

TABLE 5

| | Preparation Examples | | | | | |
|---|---|---|---|---|---|---|
| | 1 | 2 | 3 | 4 | 5 | 6 |
| Organic polyisocyanate (g) | | | | | | |
| C-HL | 100 | | | | 100 | |
| C-L | | 100 | | | | 100 |
| NCO-1 | | | 100 | 100 | | |
| Coupling agent (g) | | | | | | |
| A-1310 | 0.2 | 0.4 | 0.05 | | 5.0 | |
| A-187 | | | | | | 0.2 |
| Polyisocyanate curing | CA-1 | CA-2 | CA-3 | CA-4 | CA-5 | CA-6 |
| agent | | | | | | |
| Storage stability | ◯ | ◯ | ◯ | ◯ | ◯ | X |

In Table 5,

C-HL: a urethane-modified hexamethylene diisocyanate produced by Nippon Polyurethane Industry Co., Ltd.; brand name=Coronate HL; isocyanate group content=12.8%; solid content=75%

C-L: a urethane-modified tolylene diisocyanate produced by Nippon Polyurethane Industry Co., Ltd.; brand name=Coronate L; isocyanate group content=13.2%; solid content=75%

NCO-1: a modified polyisocyanate obtained by introducing nonionic hydrophilic group into a polyisocyanate formed by subjecting hexamethylene diisocyanate to isocyanuration; isocyanate group content=16.5%; solid content=100%

A-1310: γ-isocyanatopropyltriethoxysilane; a silane coupling agent produced by Nippon Unicar Company Limited

A-187: a γ-glycidoxypropyltrimethoxysilane; a silane coupling agent produced by Nippon Unicar Company Limited

Storage stability was evaluated by viscosity increase (%), according to the following standard.

◯: Neither viscosity increase nor deterioration in appearance is seen.

X: Viscosity increase and deterioration in appearance are seen.

As is clear from Table 5, the polyisocyanate curing agent containing an epoxy type coupling agent showed poor storage stability.

[Compounding of Adhesives]

### EXAMPLES 15 to 29 and COMPARATIVE EXAMPLES 10 to 15

A polyurethane resin solution, a polyisocyanate curing agent and an organic solvent were compounded in the proportions shown in Tables 6 to 9, to prepare 21 kinds of laminate adhesives AD-1 to AD-21. Incidentally, PU-8, PU-11 and PU-23 were inferior in storage stability; therefore, they were not made into respective adhesives and accordingly not evaluated.

Each laminate adhesive was measured for stability, curing rate, adhesion strength, adhesion strength after storage and adhesion strength after severe retort treatment.

The results are shown in Tables 6 to 9.

Incidentally, adhesion strength after severe retort treatment was measured only for the adhesives using a coupling agent. The adhesive using PU-21 was inferior in stability (pot life); therefore, the adhesive was not measured for any adhesion strength.

[Stability Test]

A laminate adhesive was prepared in an atmosphere of 25° C.×50% R.H. and placed in a 200-ml sample bottle. The bottle was sealed and kept in a thermostat water bath of 25° C. for 1 hour. Then, the bottle was taken out of the bath and the contents of the sample bottle were measured for viscosity in an atmosphere of 25° C.×50% R.H., using a B type viscometer (a product of Shibaura System K.K.). This viscosity was taken as initial viscosity. Then, the bottle was again placed in the same thermostat water bath of 25° C. and, after 8 hours or 24 hours from the measurement of the initial viscosity, viscosity measurement was made in the same manner as above.

[Measurement of Curing Rate]

A laminate adhesive was prepared in an atmosphere of 25° C.×50% R.H. and placed in a 200-ml sample bottle. The bottle was sealed and kept in a thermostat water bath of 25° C. for 1 hour. Then, the bottle was taken out of the bath and the contents of the sample bottle were subjected to infrared absorption analysis (IR analysis). After the analysis, the bottle was again placed in the same thermostat water bath of 25° C. and, after 8 hours or 48 hours from the analysis, IR analysis was made in the same manner as above.

In IR analysis, using the peak intensity ratio of (a) the isocyanate group peak intensity at 2,240 to 2,300 cm⁻¹ and (b) the methylene group peak intensity at 2,900 to 2,960 cm⁻¹, isocyanate group remaining ratio (%) was calculated from the following formulas (1) and (2); from the ratio was determined ratio of reacted laminate adhesive (which is 100% minus isocyanate group remaining ratio); and the ratio of reacted laminate adhesive was taken as curing rate of laminate adhesive.

Isocyanate group remaining ratio (%)=[(A−B)/A]×100 (1)

where

A: a peak intensity ratio right after compounding of curing agent, and

B: a peak intensity ratio after a given period of time

Peak intensity ratio=C/D (2)

where

C: a length from the base line of isocyanate group peak to the top of the peak, in IR chart, and

D: a length from the base line of methylene group peak to the top of the peak, in IR chart

Incidentally, the ordinate axis of IR chart is transmittance (%).

[Measurement-1 of Adhesion Strength After Storage]

This measurement was made for the laminate adhesives AD-1 to AD-9. An Ny film (thickness: 15 μm) and an LLDPE film (thickness: 130 μm) were set in a dry laminator. Then, a laminate adhesive was coated on the corona-treated surface of the Ny film using a gravure roll so that the as-dried amount of the adhesive coated became 3.5 g/m². The adhesive-coated Ny film was passed through a drying oven of 80° C. and then laminated with the LLDPE film using a nip roll of 80° C.×0.3 MPa, to obtain a laminated film. The film speed was 50 m/min. The laminated film was cut into a 15-mm width, and the cut sample was subjected to a T-peel test. The adhesion strength obtained was taken as initial adhesion strength. The laminated film was subjected to aging at 35° C., and sampling was made after 8 hours and 48 hours from lamination, for measurement of adhesion strength in the same manner.

[Measurement-1 of Adhesion Strength]

This measurement was made for the laminate adhesives AD-1 to AD-9. An Ny film (thickness: 15 μm) and a CPP film (thickness: 70 μm) were set in a dry laminator. Then, a laminate adhesive was coated on the corona-treated surface of the Ny film using a gravure roll so that the as-dried amount of the adhesive coated became 3.5 g/m². The adhesive-coated Ny film was passed through a drying oven of 80° C. and then laminated with the CPP film using a nip roll of 80° C.×0.3 MPa. The film speed was 50 m/min. After the lamination, aging was conducted at 35° C. for 48 hours to obtain a laminated film. This laminated film was cut into a 15-mm width and subjected to a T-peel test for measurement of adhesion strength (ordinary state).

After the lamination, aging was also conducted at 35° C. for 16 hours to obtain a laminated film. This laminated film was cut into a rectangle of 25×30 cm. Two such rectangles were laminated so that the Ny film was at the outer surface of the resulting laminate, and the three sides of the laminate other than one short side were heat-sealed under the conditions of 180° C.×0.3 MPa×1 second to form a bag. In this bag was placed a tomato ketchup/salad oil/vinegar (1/1/1 by weight ratio) mixture. The unsealed side was heat-sealed under the conditions of 180° C.×0.3 MPa×1 second. The resulting bag was subjected to a retort treatment of 120° C.×30 minutes. The laminated film constituting the bag after retort treatment was cut into a 15-mm width and the resulting sample was subjected to a T-peel test for measurement of adhesion strength after retort treatment.

[Measurement-2 of Adhesion Strength]

This measurement was made for the laminate adhesives AD-10 to AD-21. An Ny film (thickness: 15 μm) and an LLDPE film (thickness: 130 μm) were set in a dry laminator. Then, a laminate adhesive was coated on the corona-treated surface of the Ny film using a gravure roll so that the as-dried amount of the adhesive coated became 3.5 g/m². The adhesive-coated Ny film was passed through a drying oven of 80° C. and then laminated with the LLDPE film using a nip roll of 80° C.×0.3 MPa, to obtain a laminated film. The film speed was 50 m/min. The laminated film was subjected to aging at 35° C. for 48 hours and then cut into a 15-mm width. The resulting sample was subjected to a T-peel test for measurement of adhesion strength.

[Measurement-2 of Adhesion Strength After Storage]

This measurement was made for the laminate adhesives AD-10 to AD-21. A PET film (thickness: 12 μm), an aluminum foil (thickness: 9 μm) and a CPP film (thickness: 70 μm) were set in a dry laminator. Then, a laminate adhesive was coated on the corona-treated surface of the PET film using a gravure roll so that the as-dried amount of the laminate adhesive coated became 3.5 g/m². The adhesive-coated PET film was passed through a drying oven of 80° C. and adhered to the aluminum foil using a nip roll of 80° C.×0.3 MPa. Next, the same laminate adhesive was coated on the aluminum foil using a gravure roll so that the as-dried amount of the laminate adhesive coated became 3.5 g/m². The PET film/aluminum foil laminated film having the adhesive coated on the aluminum foil was passed through a drying oven of 80° C. and adhered to the corona-treated surface of the CPP film using a nip roll of 80° C.×0.3 MPa, to obtain a laminated film. The film speed was 50 m/min. The laminated film was cut into a 15-mm width and the resulting sample was subjected to a T-peel test. The adhesion strength obtained was taken as initial adhesion strength. The laminated film was subjected to aging at 35° C., sampling was made after 8 hours and 48 hours from lamination, and measurement of adhesion strength was made in the same manner.

[Measurement of Adhesion Strength After Severe Retort Treatment]

This measurement was made for the laminate adhesives AD-10 to AD-21. A PET film (thickness: 12 μm), an aluminum foil (thickness: 9 μm) and a CPP film (thickness: 70 μm) were set in a dry laminator. Then, a laminate adhesive was coated on the corona-treated surface of the PET film using a gravure roll so that the as-dried amount of the laminate adhesive coated became 3.5 g/m². The adhesive-coated PET film was passed through a drying oven of 80° C. and adhered to the aluminum foil using a nip roll of 80° C.×0.3 MPa. Next, the same laminate adhesive was coated on the aluminum foil using a gravure roll so that the as-dried amount of the laminate adhesive coated became 3.5 g/m². The PET film/aluminum foil laminated film having the adhesive coated on the aluminum foil was passed through a drying oven of 80° C. and adhered to the corona-treated surface of the CPP film using a nip roll of 80° C.×0.3 MPa, to obtain a laminated film. The film speed was 50 m/min.

After the lamination, aging was conducted at 35° C. for 48 hours. The film after aging was cut into a rectangle of 25×30 cm. Two such rectangles were laminated so that the PET film was at the outer surface of the resulting laminate, and the three sides of the laminate other than one short side were heat-sealed under the conditions of 180° C.×0.3 MPa×1 second to form a bag. In this bag was placed a tomato ketchup/salad oil/vinegar (1/1/1 by weight ratio) mixture. The unsealed side was heat-sealed under the conditions of 180° C.×0.3 MPa×1 second. The resulting bag was subjected to a severe retort treatment of 135° C.×20 minutes. The laminated film constituting the bag after retort treatment was cut into a 15-mm width and the resulting sample was subjected to a T-peel test for measurement of adhesion strength after severe retort treatment.

In the measurements of adhesion strength, adhesion strength after storage and adhesion strength after severe retort treatment, the peeling conditions used in T-peel test were as follows.

Rate of pulling: 300 mm/min

Atmosphere of measurement: 25° C.×50% R.H.

TABLE 6

| | Examples | | | | | | |
|---|---|---|---|---|---|---|---|
| | 15 | 16 | 17 | 18 | 19 | 20 | 21 |
| Polyurethane resin solution (g) | | | | | | | |
| PU-1 | 1000 | | | | | | |
| PU-2 | | 1000 | | | | | |
| PU-3 | | | 1000 | | | | |
| PU-4 | | | | 1000 | | | |
| PU-5 | | | | | 1000 | | |
| PU-6 | | | | | | 1000 | |
| PU-7 | | | | | | | 1000 |
| Polyisocyanate curing agent (g) | | | | | | | |
| CA-1 | 100 | | | | | | 100 |
| CA-2 | | 100 | | | | | |
| CA-3 | | | 75 | | | | |
| CA-4 | | | | 100 | | | |
| CA-5 | | | | | 75 | 75 | |
| Organic solvent (g) | 1200 | 1200 | 1225 | 1200 | 1225 | 1225 | 1200 |
| Ethyl acetate | | | | | | | |
| Laminate adhesive | AD-1 | AD-2 | AD-3 | AD-4 | AD-5 | AD-6 | AD-7 |
| NCO/OH (molar ratio)¹⁾ | 6.0/1 | 5.5/1 | 10.3/1 | 6.1/1 | 2.1/1 | 6.2/1 | 6.0/1 |
| Viscosity (mPa · s/25° C.) | | | | | | | |
| Right after compounding | 33 | 30 | 40 | 33 | 26 | 28 | 35 |
| After 8 hours | 36 | 31 | 42 | 35 | 27 | 29 | 36 |
| After 24 hours | 40 | 33 | 45 | 36 | 29 | 31 | 37 |
| Ratio of reacted adhesive (%) | | | | | | | |
| Right after compounding | 0 | 0 | 0 | 0 | 0 | 0 | 0 |
| After 8 hours | 83 | 62 | 90 | 63 | 83 | 74 | 77 |
| After 48 hours | 100 | 100 | 100 | 100 | 100 | 100 | 100 |
| Adhesion strength after storage | | | | | | | |
| (N/cm) | | | | | | | |
| Right after compounding | 0.8 | 0.7 | 0.7 | 0.7 | 0.8 | 0.7 | 0.8 |
| After 8 hours | 12.7 | 9.7 | 9.9 | 8.5 | 11.5 | 10.8 | 12.8 |
| After 48 hours | 13.0 | 9.8 | 10.0 | 9.1 | 11.5 | 10.9 | 12.8 |
| Adhesion strength (N/cm) | | | | | | | |
| Ordinary state | 11.0 | 8.5 | 7.3 | 8.9 | 7.2 | 7.6 | 7.5 |
| After retort treatment | 11.8 | 7.9 | 7.7 | 7.6 | 7.0 | 8.3 | 7.6 |

¹⁾In calculation of the NCO/OH (molar ratio) of laminate adhesive, the moles of OH of polyurethane resin were calculated using the number-average molecular weight of the resin.

TABLE 7

Comparative
Examples

| | 10 | 11 |
|---|---|---|
| Polyurethane resin solution (g) | | |
| PU-9 | 1000 | |
| PU-10 | | 1000 |
| Polyisocyanate curing agent (g) | | |
| CA-1 | | 100 |
| CA-4 | 100 | |
| Organic solvent (g) | 1200 | 1200 |
| Ethyl acetate | | |
| Laminate adhesive | AD-8 | AD-9 |
| NCO/OH (molar ratio)¹⁾ | 2.4/1 | 4.2/1 |
| Viscosity (mPa · s/25° C.) | | |
| Right after compounding | 25 | 31 |
| After 8 hours | 26 | 145 |
| After 24 hours | 27 | gelling |
| Ratio of reacted adhesive (%) | | |
| Right after compounding | 0 | 0 |
| After 8 hours | 16 | 77 |
| After 48 hours | 60 | 100 |
| Adhesion strength after storage | | |
| (N/cm) | | |
| Right after compounding | 0.5 | 0.8 |
| After 8 hours | 2.8 | 4.8 |
| After 48 hours | 6.4 | 4.7 |
| Adhesion strength (N/cm) | | |
| Ordinary state | 3.0 | 7.0 |
| After retort treatment | 4.2 | 7.2 |

¹⁾In calculation of the NCO/OH (molar ratio) of laminate adhesive, the moles of OH of polyurethane resin were calculated using the number-average molecular weight of the resin.

TABLE 8

| | Examples | | | | | | | |
|---|---|---|---|---|---|---|---|---|
| | 22 | 23 | 24 | 25 | 26 | 27 | 28 | 29 |
| Polyurethane resin solution (g) | | | | | | | | |
| PU-12 | 1000 | | | | | | | 1000 |
| PU-13 | | 1000 | | | | | | |
| PU-14 | | | 1000 | | | | | |
| PU-15 | | | | 1000 | | | | |
| PU-16 | | | | | 1000 | | | |
| PU-17 | | | | | | 1000 | | |
| PU-18 | | | | | | | 1000 | |
| Polyisocyanate curing agent (g) | | | | | | | | |
| CA-1 | 100 | | | | | 100 | | |
| CA-2 | | 100 | | | | | 100 | |
| CA-3 | | | 75 | | | | | 75 |
| CA-4 | | | | 75 | | | | |
| CA-5 | | | | | 100 | | | |
| Organic solvent (g) | 1200 | 1200 | 1225 | 1225 | 1200 | 1200 | 1200 | 1225 |
| Ethyl acetate | | | | | | | | |
| Laminate adhesive | AD-10 | AD-11 | AD-12 | AD-13 | AD-14 | AD-15 | AD-16 | AD-17 |
| NCO/OH (molar ratio)¹⁾ | 6.4/1 | 10/1 | 3.3/1 | 5.9/1 | 4.9/1 | 2.4/1 | 6.3/1 | 6.2/1 |
| Viscosity (mPa · s/25° C.) | | | | | | | | |
| Right after compounding | 33 | 35 | 38 | 36 | 34 | 34 | 33 | 33 |
| After 8 hours | 34 | 37 | 39 | 38 | 36 | 35 | 35 | 34 |
| After 24 hours | 36 | 39 | 40 | 39 | 37 | 36 | 36 | 35 |
| Ratio of reacted adhesive (%) | | | | | | | | |
| Right after compounding | 0 | 0 | 0 | 0 | 0 | 0 | 0 | 0 |
| After 8 hours | 65 | 63 | 60 | 62 | 65 | 66 | 68 | 71 |
| After 48 hours | 100 | 100 | 100 | 100 | 100 | 100 | 100 | 100 |
| Adhesion strength (N/cm) | 8.8 | 8.4 | 8.5 | 8.4 | 8.0 | 8.7 | 7.9 | 8.7 |
| Adhesion strength after storage | | | | | | | | |
| (N/cm) | | | | | | | | |
| PET/Al | | | | | | | | |
| Right after compounding | 2.3 | 2.0 | 1.7 | 2.1 | 1.8 | 2.1 | 2.1 | 1.7 |
| After 8 hours | 4.0 | 3.9 | 3.5 | 3.8 | 3.8 | 3.4 | 3.4 | 4.2 |
| After 48 hours²⁾ | 4.4 | 4.3 | 4.2 | 4.4 | 4.2 | 4.4 | 4.3 | 4.4 |
| Al/CPP | | | | | | | | |
| Right after compounding | 2.3 | 1.9 | 1.8 | 2.1 | 1.8 | 2.2 | 2.2 | 1.8 |
| After 8 hours | 4.8 | 4.7 | 6.0 | 6.2 | 4.6 | 4.9 | 4.3 | 6.8 |
| After 48 hours³⁾ | 6.9 | 6.5 | 7.9 | 8.3 | 6.8 | 6.4 | 6.6 | 8.1 |
| Adhesion strength after severe | | | | | | | | |
| retort treatment (N/cm) | | | | | | | | |
| PET/Al | P.I. | P.I. | P.I. | | P.I. | P.I. | P.I. | P.I. |
| Al/CPP | 6.0 | 5.8 | 5.9 | | 6.1 | 6.3 | 6.0 | 5.7 |

P.I. refers to that peeling is impossible.
¹⁾In calculation of the NCO/OH (molar ratio) of laminate adhesive, the moles of OH of polyurethane resin were calculated using the number-average molecular weight of the resin.
²⁾In the measurement of adhesion strength after storage of PET film/aluminum foil, the PET film ruptured in all of Examples 22 to 29.
³⁾In the measurement of adhesion strength after storage of aluminum foil/CPP film, the aluminum foil ruptured in Examples 22 to 28 and the CPP film ruptured in Example 29.

TABLE 9

| | Comparative Examples | | | |
|---|---|---|---|---|
| | 12 | 13 | 14 | 15 |
| Polyurethane resin solution (g) | | | | |
| PU-19 | 1000 | | | |
| PU-20 | | 1000 | | |
| PU-21 | | | 1000 | |
| PU-22 | | | | 1000 |
| Polyisocyanate curing agent (g) | 100 | 100 | 100 | 100 |
| CA-1 | | | | |
| Organic solvent (g) | 1200 | 1200 | 1200 | 1200 |
| Ethyl acetate | | | | |
| Laminate adhesive | AD-18 | AD-19 | AD-20 | AD-21 |
| NCO/OH (molar ratio)¹⁾ | 6.3/1 | 6.6/1 | 6.0/1 | 5.7/1 |
| Viscosity (mPa · s/25° C.) | | | | |
| Right after compounding | 38 | 39 | 36 | 37 |
| After 8 hours | 38 | 39 | 175 | 38 |
| After 24 hours | 39 | 40 | Gelling | 40 |
| Ratio of reacted adhesive (%) | | | | |
| Right after compounding | 0 | 0 | | 0 |
| After 8 hours | 32 | 28 | | 28 |
| After 48 hours | 50 | 46 | | 54 |
| Adhesion strength (N/cm) | 8.4 | 6.0 | | 6.3 |
| Adhesion strength after storage | | | | |
| (N/cm) | | | | |
| PET/Al | | | | |
| Right after compounding | 2.4 | 2.4 | | 2.5 |
| After 8 hours | 2.9 | 2.6 | | 2.8 |
| After 48 hours | 2.6 | 2.7 | | 2.7 |
| Al/CPP | | | | |
| Right after compounding | 2.4 | 2.4 | | 2.5 |
| After 8 hours | 5.7 | 4.3 | | 5.0 |
| After 48 hours | 6.7 | 5.0 | | 5.7 |
| Adhesion strength after severe | | | | |
| retort treatment (N/cm) | | | | |
| PET/Al | P.I. | P.I. | | P.I. |
| Al/CPP | 3.6 | 3.0 | | 2.8 |

P.I. refers to that peeling is impossible.
¹⁾In calculation of the NCO/OH (molar ratio) of laminate adhesive, the moles of OH of polyurethane resin were calculated using the number-average molecular weight of the resin.

In Tables 6 to 9,

Ny film: a corona-treated, stretched nylon film of 15 μm in thickness; N-1102 (brand name) produced by Toyobo Co., Ltd.

LLDPE film: a corona-treated, unstretched low-density polyethylene film of 130 μm in thickness; TUX-FCS (brand name) produced by Tohcello Co., Ltd.

PET film: a corona-treated polyethylene terephthalate film of 12 μm in thickness; E-5100 (brand name) produced by Toyobo Co., Ltd.

Aluminum foil: an aluminum foil of 9 μm in thickness; Al Foil C (brand name) produced by Toyo Aluminium K.K.

CPP film: a corona-treated, unstretched polypropylene film of 70 μm in thickness; RXC-11 (brand name) produced by Tohcello Co., Ltd.

The laminate adhesives of the present invention showed a sufficient adhesion strength in a short aging time of 48 hours at 35° C. (conventional adhesives need an aging time of 72 hours or more at 35° C.), a pot life longer than that of conventional adhesives, and good storage stability.

Meanwhile, PU-9 containing no introduced tertiary amine, when compounded with a polyisocyanate curing agent, was sufficient in pot life (adhesive stability), but was small in curing rate and insufficient in various adhesion strengths. PU-10 containing introduced tertiary amino group in too large an amount was sufficient in curing rate and various adhesion strengths, but was insufficient in pot life.

What is claimed is:

1. A non-aqueous laminate adhesive comprising:
a tertiary amino group-containing polyurethane resin (A) obtained by reacting an active hydrogen group-containing compound comprising at least one or more kinds of compounds selected from the group consisting of compounds represented by the following formulas (1), (2), (3) and (4), with an organic polyisocyanate with the active hydrogen group being present in excess, and
a polyisocyanate curing agent,
wherein the content of the tertiary amino group in the tertiary amino group-containing polyurethane resin (A) is 0.001 to 1 mmol/g. 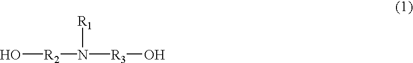
(wherein R₁ is a monovalent hydrocarbon group having 1 to 10 carbon atoms, and R₂ and R₃ may be the same or different and are each a divalent hydrocarbon group having 1 to 10 carbon atoms). 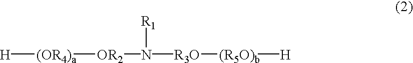
[wherein R₁ is a monovalent hydrocarbon group having 1 to 10 carbon atoms; R₂ and R₃ may be the same or different and are each a divalent hydrocarbon group having 1 to 10 carbon atoms; R₄ and R₅ may be the same or different and are each a divalent organic group having 1 to 10 carbon atoms; and a and b are each such an integer of 0 or more that the number-average molecular weight of the compound of the formula (2) becomes 300 to 10,000]. 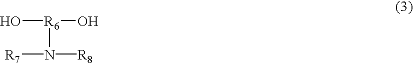
(wherein R₆ is a trivalent hydrocarbon group having 1 to 10 carbon atoms, and R₇ and R₈ may be the same or different and are each a monovalent hydrocarbon group having 1 to 10 carbon atoms). 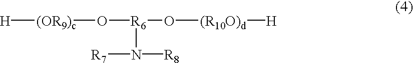
[wherein R₆ is a trivalent hydrocarbon group having 1 to 10 carbon atoms; R₇ and R₈ may be the same or different and are each a monovalent hydrocarbon group having 1 to 10 carbon atoms; R₉ and R₁₀ may be the same or different and are each a divalent organic group having 1 to 10 carbon atoms; and c and d are each such an integer of 0 or more that the number-average molecular weight of the compound of the formula (4) becomes 300 to 10,000].

2. The non-aqueous laminate adhesive according to claim 1, wherein the ratio of the moles of the total active hydrogen groups in the tertiary amino group-containing polyurethane resin (A) and the moles of the total isocyanate groups in the polyisocyanate curing agent is 1:20 to 20:1.

3. A non-aqueous laminate adhesive comprising:
a tertiary amino group-containing polyurethane resin (A) obtained by reacting an active hydrogen group-containing compound comprising at least one or more kinds of compounds selected from the group consisting of compounds represented by the following formulas (1), (2), (3) and (4), with an organic polyisocyanate with the active hydrogen group being present in excess,
a polyisocyanate curing agent, and
a silane coupling agent represented by the following formula (7),
wherein the content of the tertiary amino group in the tertiary amino group-containing polyurethane resin (A) is 0.001 to 1 mmol/g. 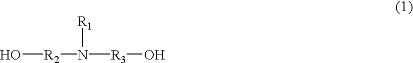
(wherein R₁ is a monovalent hydrocarbon group having 1 to 10 carbon atoms, and R₂ and R₃ may be the same or different and are each a divalent hydrocarbon group having 1 to 10 carbon atoms). 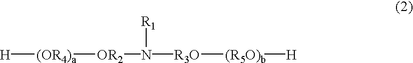
[wherein R₁ is a monovalent hydrocarbon group having 1 to 10 carbon atoms; R₂ and R₃ may be the same or different and are each a divalent hydrocarbon group having 1 to 10 carbon atoms; R₄ and R₅ may be the same or different and are each a divalent organic group having 1 to 10 carbon atoms; and a and b are each such an integer of 0 or more that the number-average molecular weight of the compound of the formula (2) becomes 300 to 10,000]. 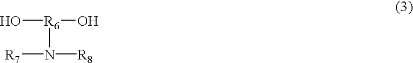
(wherein R₆ is a trivalent hydrocarbon group having 1 to 10 carbon atoms, and R₇ and R₈ may be the same or different and are each a monovalent hydrocarbon group having 1 to 10 carbon atoms). 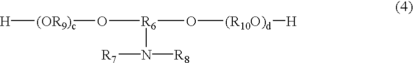
[wherein R₆ is a trivalent hydrocarbon group having 1 to 10 carbon atoms; R₇ and R₈ may be the same or different and are each a monovalent hydrocarbon group having 1 to 10 carbon atoms; R₉ and R₁₀ may be the same or different and are each a divalent organic group having 1 to 10 carbon atoms; and c and d are each such an integer of 0 or more that the number-average molecular weight of the compound of the formula (4) becomes 300 to 10,000].
OCN—(CH₂)ₘ—Si(OR)₃ (7)
(wherein R is a methyl group or an ethyl group, and m is an integer of 1 to 5).

4. The non-aqueous laminate adhesive according to claim 3, wherein the ratio of the moles of the total active hydrogen groups in the tertiary amino group-containing polyurethane resin (A) and the moles of the total isocyanate groups in the polyisocyanate curing agent is 1:20 to 20:1.

5. A non-aqueous laminate adhesive comprising:
a tertiary amino group- and carboxyl group-containing polyurethane resin (B) obtained by reacting an active hydrogen group-containing compound comprising at least (a) one or more kinds of compounds selected from the group consisting of compounds represented by the following formulas (1), (2), (3) and (4) and (b) one or two kinds of compounds selected from the group consisting of compounds represented by the following formulas (5) and (6), with an organic polyisocyanate with the active hydrogen group being present in excess, and
a polyisocyanate curing agent,
wherein the content of the tertiary amino group and the content of the carboxyl group in the tertiary amino group- and carboxyl group-containing polyurethane resin (B) are each 0.001 to 1 mmol/g. 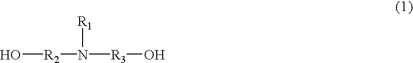
(wherein R₁ is a monovalent hydrocarbon group having 1 to 10 carbon atoms, and R₂ and R₃ may be the same or different and are each a divalent hydrocarbon group having 1 to 10 carbon atoms). 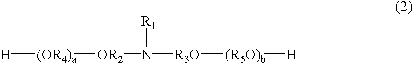
[wherein R₁ is a monovalent hydrocarbon group having 1 to 10 carbon atoms; R₂ and R₃ may be the same or different and are each a divalent hydrocarbon group having 1 to 10 carbon atoms; R₄ and R₅ may be the same or different and are each a divalent organic group having 1 to 10 carbon atoms; and a and b are each such an integer of 0 or more that the number-average molecular weight of the compound of the formula (2) becomes 300 to 10,000]. 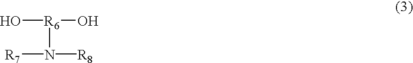
(wherein R₆ is a trivalent hydrocarbon group having 1 to 10 carbon atoms, and R₇ and R₈ may be the same or different and are each a monovalent hydrocarbon group having 1 to 10 carbon atoms). 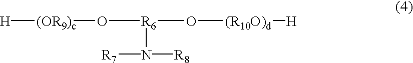
[wherein R₆ is a trivalent hydrocarbon group having 1 to 10 carbon atoms; R₇ and R₈ may be the same or different and are each a monovalent hydrocarbon group having 1 to 10 carbon atoms; R₉ and R₁₀ may be the same or different and are each a divalent organic group having 1 to 10 carbon atoms; and c and d are each such an integer of 0 or more that the number-average molecular weight of the compound of the formula (4) becomes 300 to 10,000]. 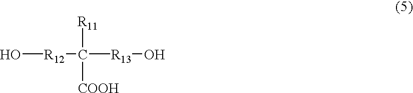
(wherein R₁₁ is a monovalent hydrocarbon group having 1 to 10 carbon atoms, and R₁₂ and R₁₃ may be the same or different and are each a divalent hydrocarbon group having 1 to 10 carbon atoms). 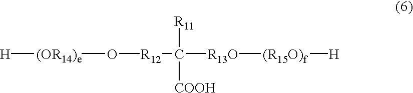
[wherein R₁₁ is a monovalent hydrocarbon group having 1 to 10 carbon atoms; R₁₂ and R₁₃ may be the same or different and are each a divalent hydrocarbon group having 1 to 10 carbon atoms; R₁₄ and R₁₅ may be the same or different and are each a divalent organic group having 1 to 10 carbon atoms; and e and f are each such an integer of 0 or more that the number-average molecular weight of the compound of the formula (6) becomes 300 to 10,000].

6. The non-aqueous laminate adhesive according to claim 5, wherein the ratio of the moles of the total active hydrogen groups in the tertiary amino group- and carboxyl group-containing polyurethane resin (B) and the moles of the total isocyanate groups in the polyisocyanate curing agent is 1:20 to 20:1.

7. A non-aqueous laminate adhesive comprising:
a tertiary amino group- and carboxyl group-containing polyurethane resin (B) obtained by reacting an active hydrogen group-containing compound comprising at least (a) one or more kinds of compounds selected from the group consisting of compounds represented by the following formulas (1), (2), (3) and (4) and (b) one or two kinds of compounds selected from the group consisting of compounds represented by the following formulas (5) and (6), with an organic polyisocyanate with the active hydrogen group being present in excess,
a polyisocyanate curing agent, and
a silane coupling agent represented by the following formula (7),
wherein the content of the tertiary amino group and the content of the carboxyl group in the tertiary amino group- and carboxyl group-containing polyurethane resin (B) are each 0.001 to 1 mmol/g. 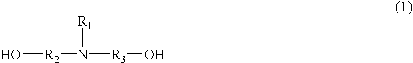
(wherein R₁ is a monovalent hydrocarbon group having 1 to 10 carbon atoms, and R₂ and R₃ may be the same or different and are each a divalent hydrocarbon group having 1 to 10 carbon atoms). 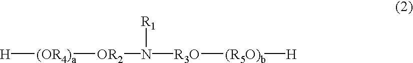
[wherein R₁ is a monovalent hydrocarbon group having 1 to 10 carbon atoms; R₂ and R₃ may be the same or different and are each a divalent hydrocarbon group having 1 to 10 carbon atoms; R₄ and R₅ may be the same or different and are each a divalent organic group having 1 to 10 carbon atoms; and a and b are each such an integer of 0 or more that the number-average molecular weight of the compound of the formula (2) becomes 300 to 10,000]. 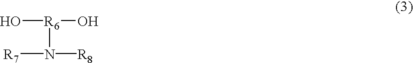
(wherein R₆ is a trivalent hydrocarbon group having 1 to 10 carbon atoms, and R₇ and R₈ may be the same or different and are each a monovalent hydrocarbon group having 1 to 10 carbon atoms). 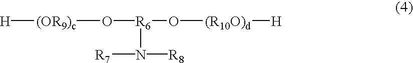
[wherein R₆ is a trivalent hydrocarbon group having 1 to 10 carbon atoms; R₇ and R₈ may be the same or different and are each a monovalent hydrocarbon group having 1 to 10 carbon atoms; R₉ and R₁₀ may be the same or different and are each a divalent organic group having 1 to 10 carbon atoms; and c and d are each such an integer of 0 or more that the number-average molecular weight of the compound of the formula (4) becomes 300 to 10,000]. 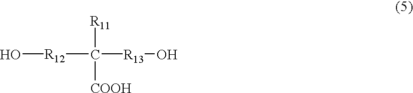
(wherein R₁₁ is a monovalent hydrocarbon group having 1 to 10 carbon atoms, and R₁₂ and R₁₃ may be the same or different and are each a divalent hydrocarbon group having 1 to 10 carbon atoms). 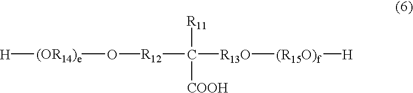
[wherein R₁₁ is a monovalent hydrocarbon group having 1 to 10 carbon atoms; R₁₂ and R₁₃ may be the same or different and are each a divalent hydrocarbon group having 1 to 10 carbon atoms; R₁₄ and R₁₅ may be the same or different and are each a divalent organic group having 1 to 10 carbon atoms; and e and f are each such an integer of 0 or more that the number-average molecular weight of the compound of the formula (6) becomes 300 to 10,000].
OCN—(CH₂)ₘ—Si(OR)₃ (7)
(wherein R is a methyl group or an ethyl group, and m is an integer of 1 to 5).

8. The non-aqueous laminate adhesive according to claim 7, wherein the ratio of the moles of the total active hydrogen groups in the tertiary amino group- and carboxyl group-containing polyurethane resin (B) and the moles of the total isocyanate groups in the polyisocyanate curing agent is 1:20 to 20:1.
